(19) United States
(12) Patent Application Publication
(10) Pub. No.: US 2005/0177545 A1
(43) Pub. Date: Aug. 11, 2005

(54) Method and apparatus for representing and managing service level agreement management data and relationships thereof

(75) Inventors: Melissa Jane Buco, Amawalk, NY (US); Rong Nickle Chang, Pleasantville, NY (US); Laura Zaihua Luan, Putnam Valley, NY (US); Zon-Yin Shae, South Salem, NY (US); Christopher Ward, Glen Ridge, NJ (US); Joel Leonard Wolf, Katonah, NY (US); Philip Shi-Lung Yu, Chappaqua, NY (US)

Correspondence Address: Ryan, Mason & Lewis, LLP, 90 Forest Avenue, Locust Valley, NY, 11560, US

(73) Assignee: International Business Machines Corporation, Armonk, NY (US)

(21) Appl. No.: 10/776,548

(22) Filed: Feb. 11, 2004

(51) Int. Cl. G06F 7/00

(52) U.S. Cl. 707/1

(57) ABSTRACT

Techniques are provided for representing and managing data and associated relationships. In one aspect of the invention, a technique for managing data associated with a given domain comprises the following steps. A specification of data attributes representing one or more types of data to be managed is maintained. Further, a specification of algorithms representing one or more types of operations performable in accordance with the data attributes is maintained. Still further, a specification of relationships representing relationships between the data attributes and the algorithms is maintained. The data attribute specification, the algorithm specification and the relationship specification are maintained in a storage framework having multiple levels, the multiple levels being specified based on the given domain with which the data being managed is associated. The techniques may be provided in support of service level management. In such a domain, the present invention provides techniques for representing and managing service level agreement management data using a multi-level multi-ontology metadata store and extensible service level management framework.

### FIELD OF THE INVENTION

The present invention relates generally to representing and managing data and the relationships between data, and more particularly, to techniques for representing and managing data and associated relationships in support of service level management.

### BACKGROUND OF THE INVENTION

Existing e-utility (electronic utility) and IT (information technology) service providers are required to efficiently manage the services provided to customers and generate SLA compliance reports for their customers. Management of the service in business terms (i.e., with a full understanding of the business ramifications of meeting or failing to meet service level commitments) and SLA compliance report generation both require detailed knowledge of service level management data and the relationships between such data.

Service level management related contractual data may include the data that cannot or need not be explicitly included in the SLA document (e.g., unscheduled conditional service maintenance periods, recurring monthly service charges, etc.). Service quality management data may include the provider's service quality management data.

For example, a managed storage service contract that offers virtual disk space to a customer with an availability target requires the provider to manage the mapping between the virtual disk space and the corresponding physical storage resources. The service level management related contractual data in this case may comprise all contractually described data attributes associated with the availability of the virtual disk, including pricing, required capacity, availability target, etc. The corresponding set of service quality management data may include the data attributes associated with this mapping (e.g., physical storage server names, allocated capacity, etc.).

While the service quality management data and the relationships between the service level management related contractual data and the service quality management data must be managed well by the provider, such non-contractual implementation details do not have to be exposed to the customer. The effective management of such data and the associated relationships is a complex challenge.

In accordance with existing approaches, much of the service quality management data is maintained in a variety of disparate repositories in various locations in the service delivery centers including databases, text documents in file systems, printed documents etc. Many of the essential data relationships are recorded likewise in paper documents, embedded in the program logic of various applications and monitoring tools, reporting engines, and work flow processes. Little if any of the essential nature of the various data items are annotated in a clear and systematic manner. Because of this, an accurate understanding of the computational steps required to generate service level reports and to manage the contracts in business terms is difficult if not impossible to achieve.

Further, in accordance with existing approaches, SLA reporting is an extremely time consuming process with many manual steps (due to insufficient management of data and relationship mappings) and management of the customer contracts in business terms is poorly understood.

Accordingly, there is a need for effective and efficient techniques for capturing and managing service level management related contractual data, service quality management data, and the like, as well as relationships between such data, in support of SLA-driven service quality management.

### SUMMARY OF THE INVENTION

The present invention provides techniques for representing and managing data and associated relationships.

In one aspect of the invention, a technique for managing data associated with a given domain comprises the following steps. A specification of data attributes representing one or more types of data to be managed is maintained. Further, a specification of algorithms representing one or more types of operations performable in accordance with the data attributes is maintained. Still further, a specification of relationships representing relationships between the data attributes and the algorithms is maintained. The data attribute specification, the algorithm specification and the relationship specification are maintained in a storage framework having multiple levels, the multiple levels being specified based on the given domain with which the data being managed is associated. The invention also provides apparatus, article of manufacture, and data store aspects having similar features.

In another aspect of the invention, a method of providing a service for managing data associated with a given domain comprises the step of a service provider providing a data management system in accordance with one or more customers. The data management system is operative to maintain a specification of data attributes, a specification of algorithms, a specification of relationships representing relationships between the data attributes and the algorithms, as mentioned in the above aspects of the invention.

It is to be appreciated that such techniques may be used in support of service level management. The present invention realizes that it is often unappreciated that SLA compliance reporting related data (e.g., quality metric types, service level computation algorithms, etc.) is a proper subset of the SLM related contractual data (e.g., pricing structure, SLA rebate computation algorithms, etc.) that is important for this business-oriented SLA management. The invention therefore provides an innovative approach to the challenge of representing and managing SLA management data by the appropriate application of a multi-level multi-ontology metadata store and extensible SLM framework.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a pictorial representation illustrating a data processing system in which the present invention may be implemented, according to an embodiment of the present invention;

FIG. 2 is a block diagram illustrating a data processing system in which the present invention may be implemented, according to an embodiment of the present invention;

FIG. 3 is a diagram illustrating linkage between SLA contract elements and SLM data through a staged approach, according to an embodiment of the present invention;

FIG. 4 is a diagram illustrating an extensible SLM data management framework and its exposure to e-utility service provider service level management applications, according to an embodiment of the present invention;

FIG. 5 is a diagram illustrating a data management framework supported by a layered model representing data, algorithms and relationships according to an embodiment of the present invention;

FIG. 6 is a flow graph illustrating operation of data management in response to receiving an application request, according to an embodiment of the present invention;

FIGS. 7A and 7B are a flow graph illustrating a QoS Management module, according to an embodiment of the present invention;

FIGS. 8A and 8B are a flow graph illustrating an Integrity Control module, according to an embodiment of the present invention;

FIG. 9 is a flow graph illustrating an SLM Element Extraction module, according to an embodiment of the present invention;

FIGS. 10A and 10B are a flow graph illustrating an SLM Relationship Extraction module, according to an embodiment of the present invention;

FIG. 11 is a flow graph illustrating an Update module, according to an embodiment of the present invention;

FIGS. 12A and 12B are flow graphs illustrating a Flow Data Execution module, according to an embodiment of the present invention;

FIG. 13 is a flow graph illustrating a Provisioning Template Management module, according to an embodiment of the present invention;

FIG. 14 is a diagram illustrating a representation of an SLMDataElement from both a Service Offering Specification and from a Contract Instance Specification, according to an embodiment of the present invention;

FIG. 15 is a diagram illustrating progressive specification refinement for an SLMAlgElement from both an SLA management domain specification and from a service offering specification, according to an embodiment of the present invention;

FIG. 16 is a diagram illustrating progressive specification refinement within a particular layer, according to an embodiment of the present invention;

FIG. 17 is a diagram illustrating SLM specification refinement through levels, according to an embodiment of the present invention;

FIG. 18 is a diagram illustrating the representation of relationship management for contract instances used in this embodiment;

FIG. 19A is a diagram illustrating evaluation of an exposed business impact and of a service level attainment computation represented by a processing relationship, according to an embodiment of the present invention;

FIG. 19B is a diagram illustrating the elements <Orchestration> and <ProcessingRelationship>, according to an embodiment of the present invention;

FIG. 19C is a diagram illustrating how a path is created through a data flow graph using processing orchestration, according to an embodiment of the present invention;

FIG. 20 is a diagram illustrating computation of processing flow between end points using a data model, according to an embodiment of the present invention;

FIG. 21 is a diagram illustrating a processing relationship used in a first stage of computing a service level, according to an embodiment of the present invention;

FIG. 22 is a diagram illustrating a data specification (SLMDataElement) for an input to a demonstration step, according to an embodiment of the present invention;

FIG. 23 is a diagram illustrating actual data that would be retrieved from a data store, according to an embodiment of the present invention;

FIG. 24A is a diagram illustrating an algorithm specification that describes data to be passed into and out of the algorithm “ResTimeSLEAlgorithm_1_ContractualSL”, according to an embodiment of the present invention;

FIG. 24B is a diagram illustrating an algorithm specification that describes the SLA contract view of the data to be passed into and out of the service level evaluation algorithm “ResTimeSLEAlgorithm_contractualSL”, according to an embodiment of the present invention;

FIG. 24C is a diagram illustrating an algorithm specification that describes data to be passed into and out of the algorithm “ResTimeSLEAlgorithm_2_ContractualSL”, according to an embodiment of the present invention;

FIG. 25 is a diagram illustrating a data specification for output to a demonstration step, according to an embodiment of the present invention;

FIG. 26 is a diagram illustrating actual data that would be stored in a data store, according to an embodiment of the present invention;

FIG. 27 is a diagram illustrating how a processing step is handled by an extensible data management framework and how data is retrieved, processed by an algorithm, and is returned back into a repository, according to an embodiment of the present invention; and

FIG. 28 is a diagram illustrating how a data management framework may accommodate non-semi-structured data, according to an embodiment of the present invention.

### DETAILED DESCRIPTION OF PREFERRED EMBODIMENTS

It is to be understood that while the present invention will be described below in the context of service level management, the invention is not so limited. Rather, the invention is more generally applicable to any environment in which it would be desirable to provide effective and efficient techniques for capturing and managing various types of data and the relationships between such data.

As will be illustratively explained below, the invention provides an innovative approach to the challenge of representing and managing SLA management data by the appropriate application of a multi-level multi-ontology metadata store and extensible service level management (SLM) framework. As used illustratively herein, the term “SLM data” is intended to generally refer to all data that is required in the management of e-utility service level agreements and includes the SLA contractual data (referred to illustratively herein as “SLA data”) that is jointly agreed upon by the customer and the provider. The advantage of this approach is that it addresses key technical challenges by systematically maintaining the management data references associated with the application domain (in this case, service level reporting and proactive management of the e-utilities business based on business impact analysis) and the processing relationships between the application elements (algorithms) in support of fulfilling the service (in this case, service level reporting/action management).

Advantageously, as will be explained below, the following are some of the illustrative features that the invention provides:
1. Design of an extensible SLM data management framework (architecture) which facilitates access to the data store in a consistent manner regardless of the underlying implementation.
2. Representation of the data through a multi-layer data model which expressly represents the data, algorithms and a multiplicity of relationships including relational, processing, SLM/SLA and taxonomy relationships.
3. Relationship mapping between data elements based on the characteristics, notably the identification of processing relationships, schema relationships, and SLA/SLM relationships based on a SLM domain specific multidimensional ontology.
4. Representation of core modules that is independent of external system allowing extensive reuse of algorithms for service level management (e.g., SL (service level) attainment and business impact computation).
5. Linkage to external systems is isolated to “edges” of the system using “StructureBinding” and data translation.
6. Use of a metadata store to represent selected common characteristics that will be used in support of typical SLM related functions, e.g., SL Reporting, notably, the ‘category’, the ‘role’ of the element, the type, and the ‘name’, etc.
7. Processing relationship mappings that leverage the data elements based on the ‘processing relationships’ and ‘orchestrations.’
8. Representation of SLM related algorithms in a generic form such that they may be used in a number of different service level computations and other SLM related tasks.
9. Composition and validation of ‘semantic fragments’ to maintain data integrity between semantic elements.
10. Representation of processing orchestrations that represents the sequence of processing relationships that are used in support of SLM relevant processing functions.

According to the various exemplary embodiments of the present invention, a technique is provided to enable applications to access and process data in accordance with a characterization of the data and the relationships between the data as set forth in this invention.

1. Architecture

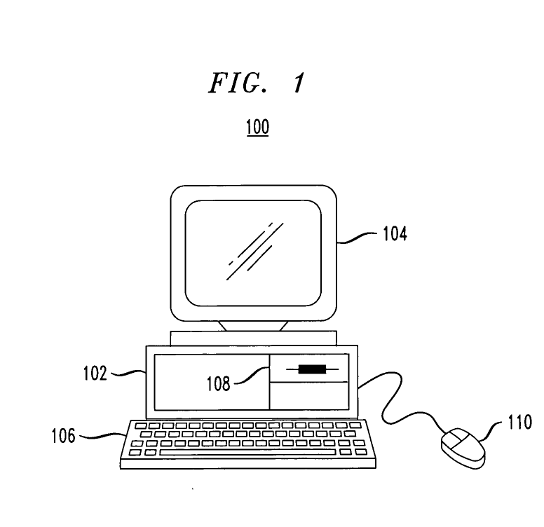

With reference now to the figures and in particular with reference to FIG. 1, a pictorial representation of a data processing system in which the present invention may be implemented is depicted in accordance with an embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented via systems software residing in computer readable media in operation within computer 100.

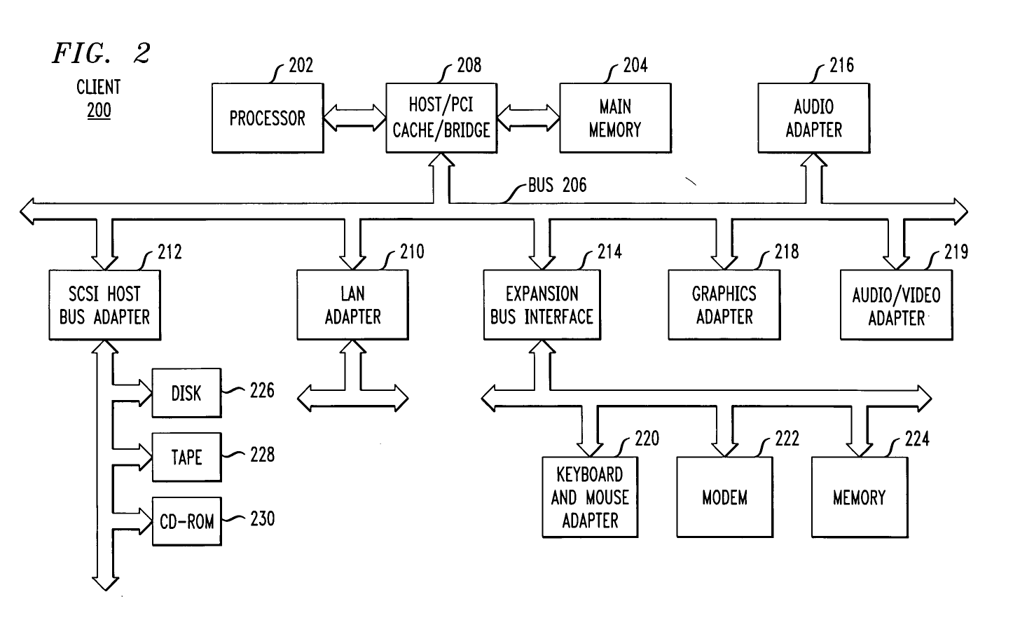

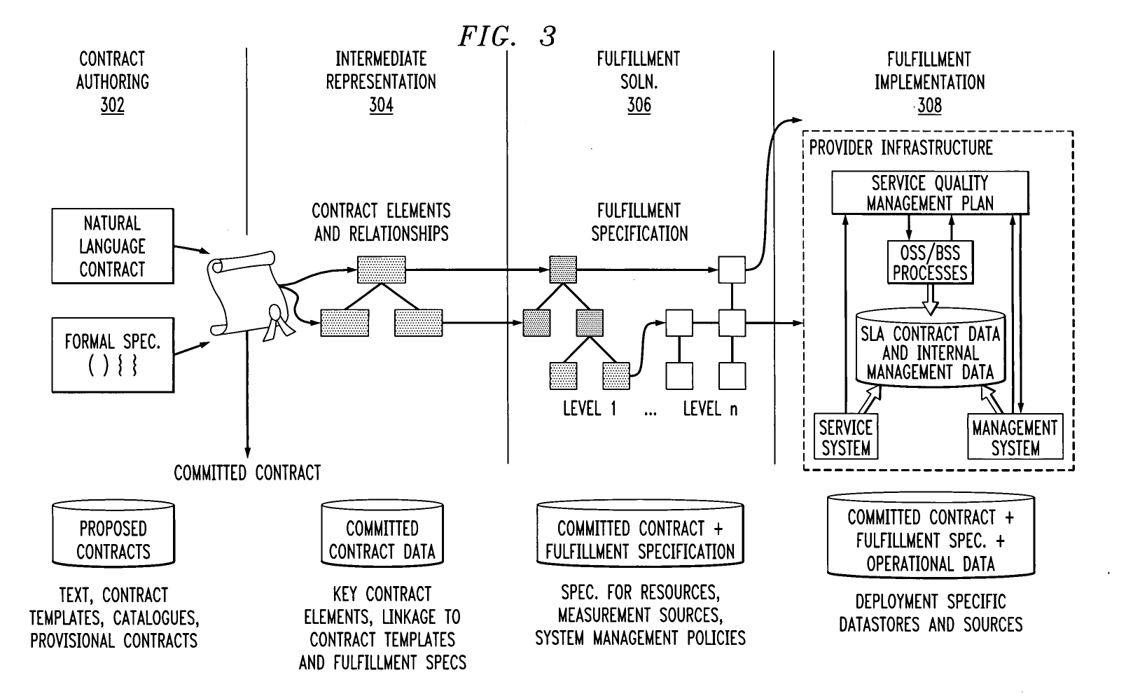

With reference now to FIG. 2, a block diagram of a data processing system is shown in which the present invention may be implemented. Data processing system 200 is an example of a computer, such as computer 100 in FIG.1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards.

In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object-oriented programming system such as Java may run in conjunction with the operating system and provides calls to the operating system from Java programs or applications executing on data processing system 200. “Java” is a trademark of Sun Microsystems, Inc. A database management system such as DB2 may run in conjunction with the operating system and provide persistent storage for Java programs or application execution on data processing system 200. An embodiment for the database management system contemplated for this data management framework may be one with native support for semi-structured data such as XML (Extensible Markup Language). DB2 is a trademark of International Business Machines Inc. Instructions for the operating system, the object-oriented programming system, the database management system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and the above-described examples are not meant to imply architectural limitations. For example, data processing system 200 also may be a notebook computer or hand held computer in addition to taking the form of a PDA Data processing system 200 also may be a kiosk or a Web appliance. Data processing system 200 may also represent one or more servers. The processes of the present invention are performed by processor 202 using computer-implemented instructions, which may be located in a memory such as, for example, main memory 204, memory 224, or in one or more peripheral devices 226-230.

2. Overview

FIG. 3 illustrates pictorially the nature of the problem that is to be addressed and provides a high level perspective of the solution. The problem to be addressed is that of relating the SLA contract data (contract specific relevant data) with service level management data (fulfillment specific implementation data) in a manner that it can be effectively accessed and used in support of SLA management functions including reporting and business analytics.

More particularly, FIG. 3 illustrates a staged approach to capturing and managing SLA/SLM data based upon contract life cycle management activities. The SLA data is established during a Contract Authoring phase 302 and may be represented in a variety of formats (e.g., printed text, tables, arithmetic formulas, or formal language specifications).

Once signed, the SLA data is extracted and represented in a Common Intermediate Representation 304, independent of how it is to be fulfilled. This data is then associated with a Fulfillment Solution 306, a multi-layered implementation-independent relationship graph of the SLA related SLM data. For example, for a managed storage service contract, the SLA data refers to the storage service components and associated service levels, while the SLM data in the Fulfillment Solution refers to (at level 1) the set of attributes required to compute the contractual/internal service levels for the contract and links them (at level 2) to the set of fulfillment linkage specifications which locate the relevant data and algorithms. Exact details of the Fulfillment Solution are related to the nature of the contracts supported in an SLA Action Management System or SAM (i.e. the set of contract offerings represented in the Common Intermediate Representation) and could incorporate many linkage levels.

Finally, the Fulfillment Implementation 308 (e.g., service delivery environment configurations and other sources of relevant data) stores the actual SLM data in a variety of databases and locales as referenced by the Fulfillment Solution. Specific details of this architecture are described below.

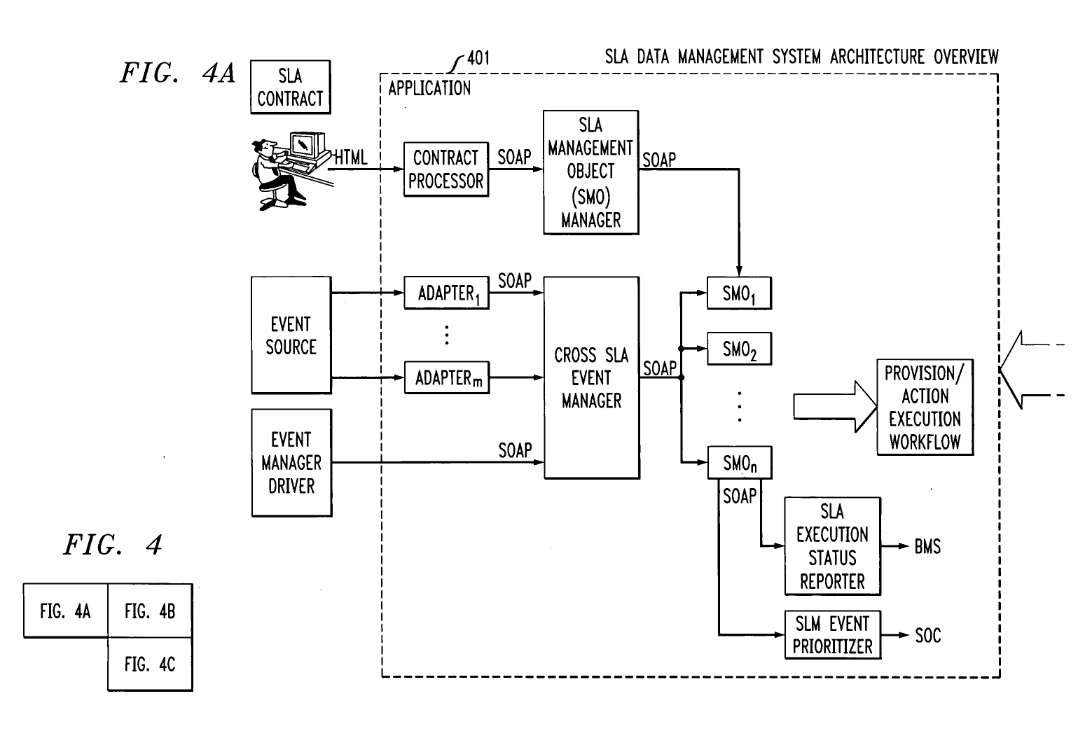

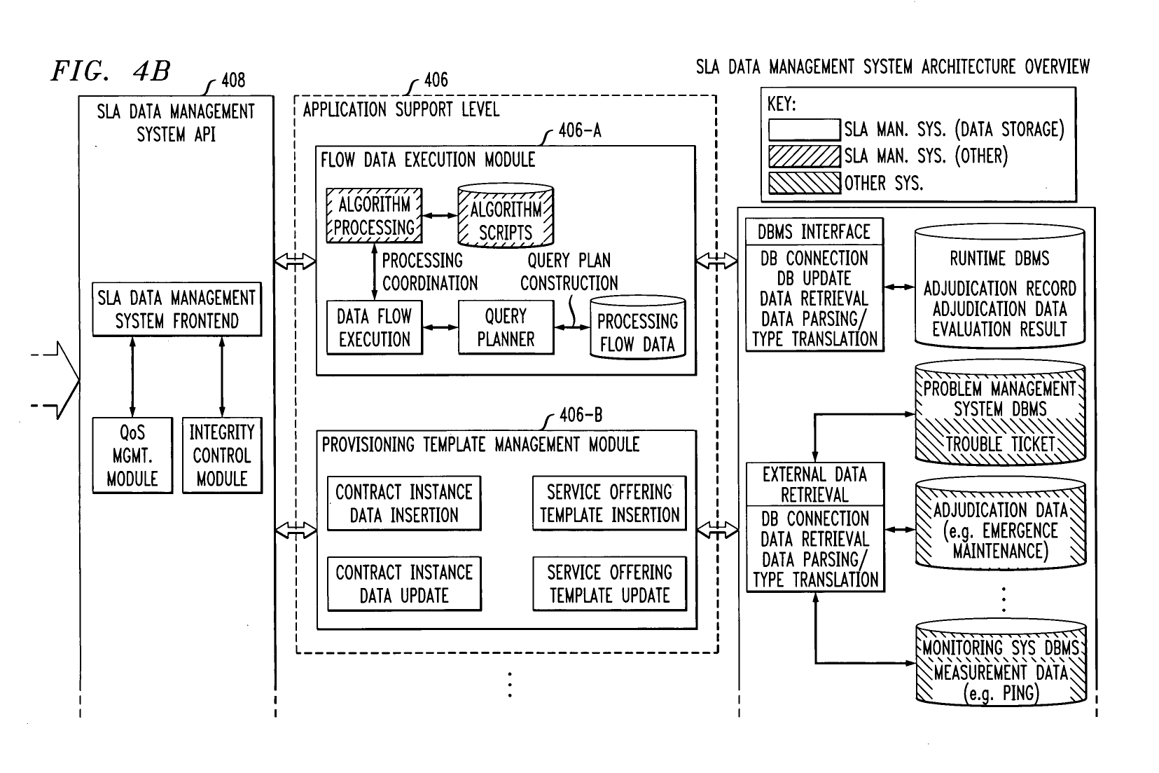

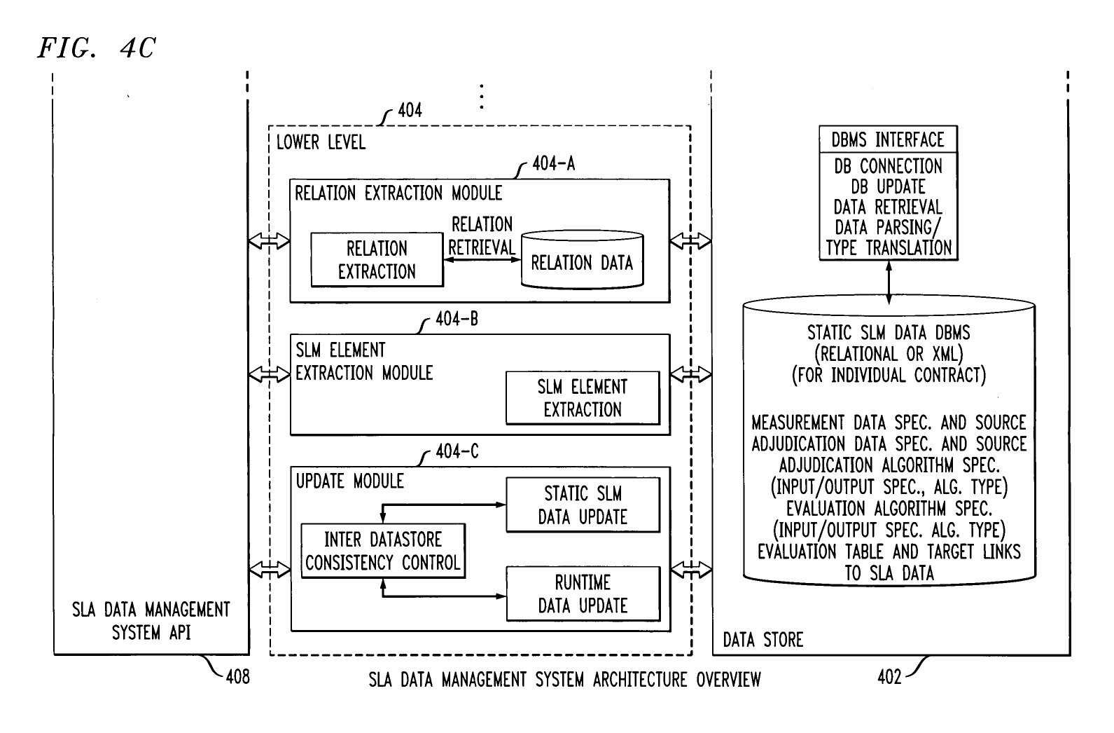

FIG. 4 illustrates an embodiment of the architecture for the extensible SLM Data Management Framework (right-side components) and its interaction with the systems that makes use of it (a SAM 401 depicted in accordance with left-side components). The primary component of the SLA Management Framework is a Data Store 402. The Data Store 402 contains the Static SLM Data for individual contracts which may be relational or XML and a runtime Data Base Management System in which intermediate results are stored (a relational database in one embodiment). In addition, the Data Store includes various other sources of data referenced from the Static SLM data, e.g., raw measurement data sources, adjudication data sources, etc.

The middle region of the right-side of FIG. 4 illustrates a number of “plug-in” modules for accessing and managing the data (described below more fully in the context of FIG. 6). The modules are divided into two sets, Lower Level 404 and Application Support Level 406.

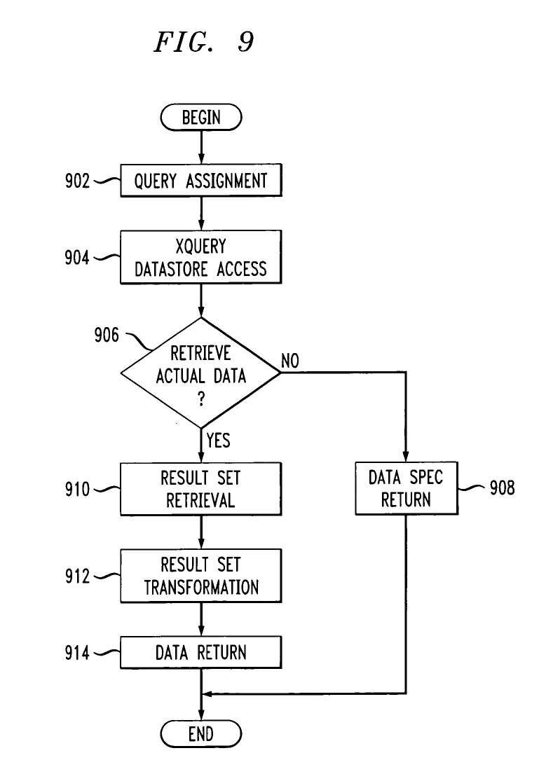

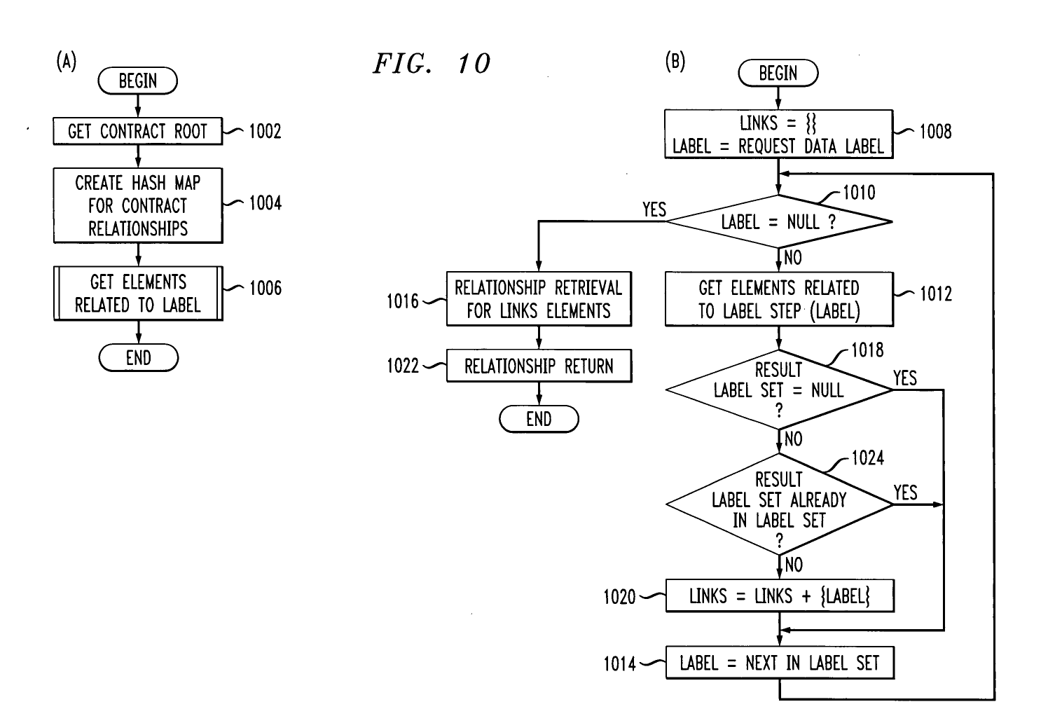

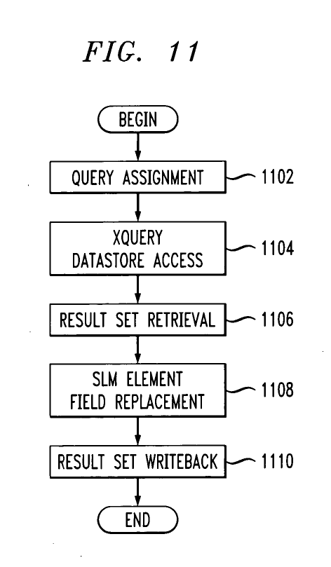

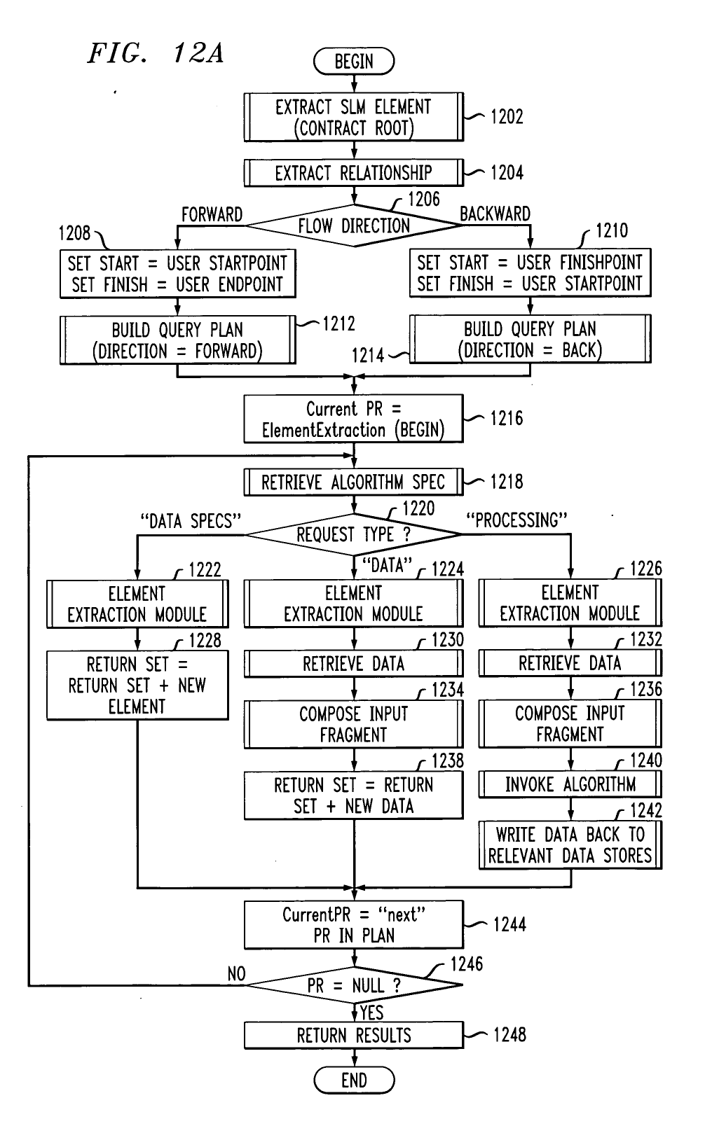

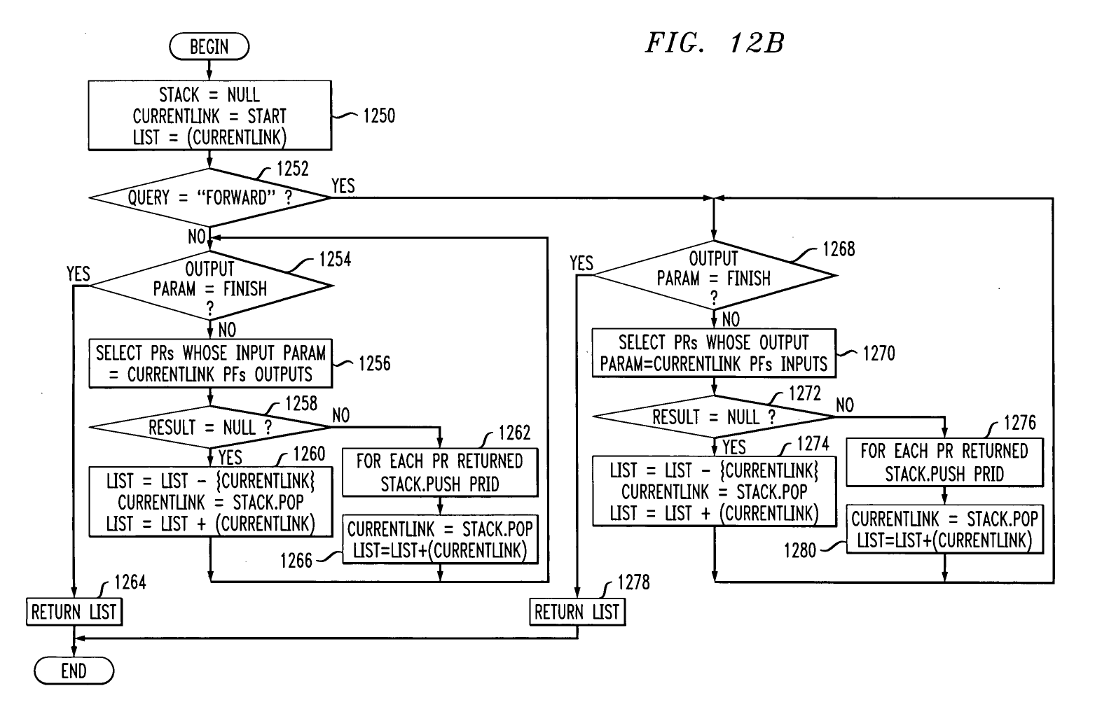

The Lower Level 404 modules provide for Relationship Extraction 404-A (described below more fully in the context of FIG. 10), SLM Element Extraction 404-B (described below more fully in the context of FIG. 9) and Element Update 404-C (described below more fully in the context of FIG. 11) and may be considered data store access functions within the Data Model abstraction.

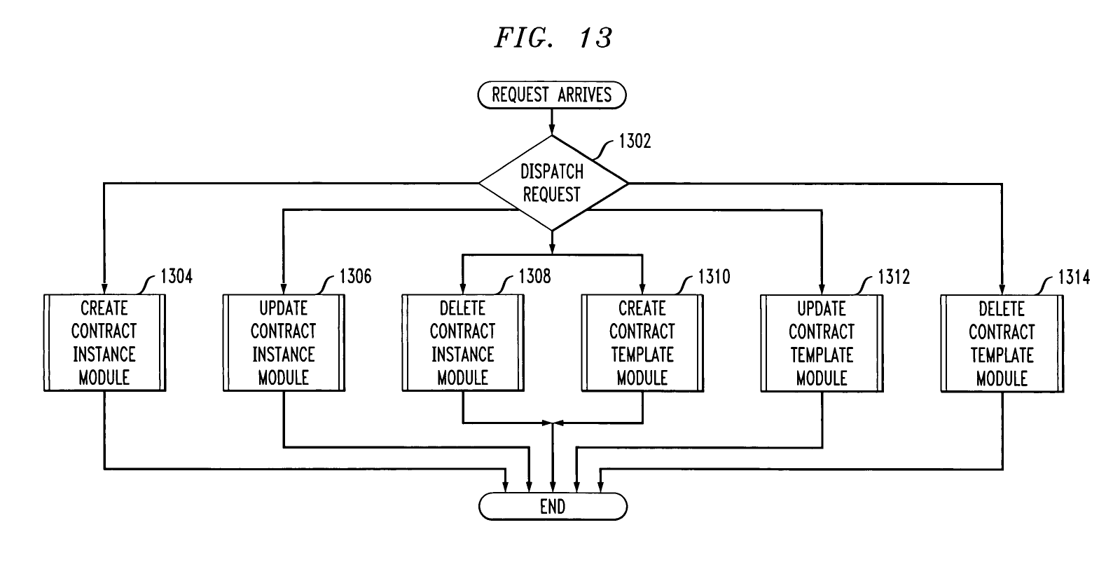

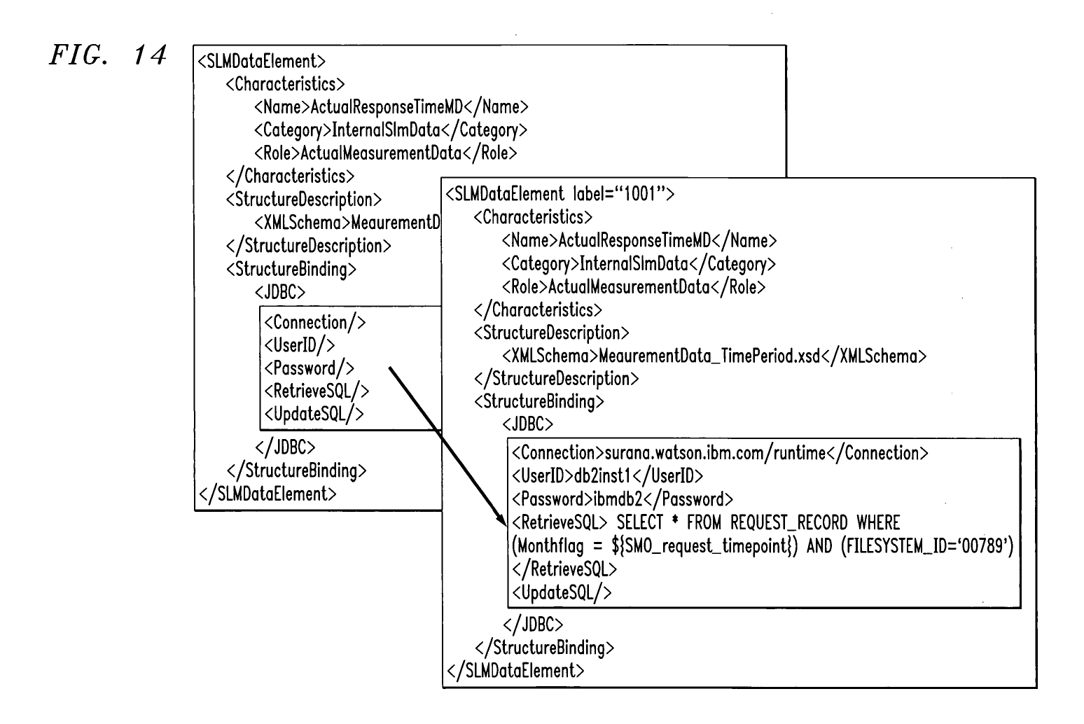

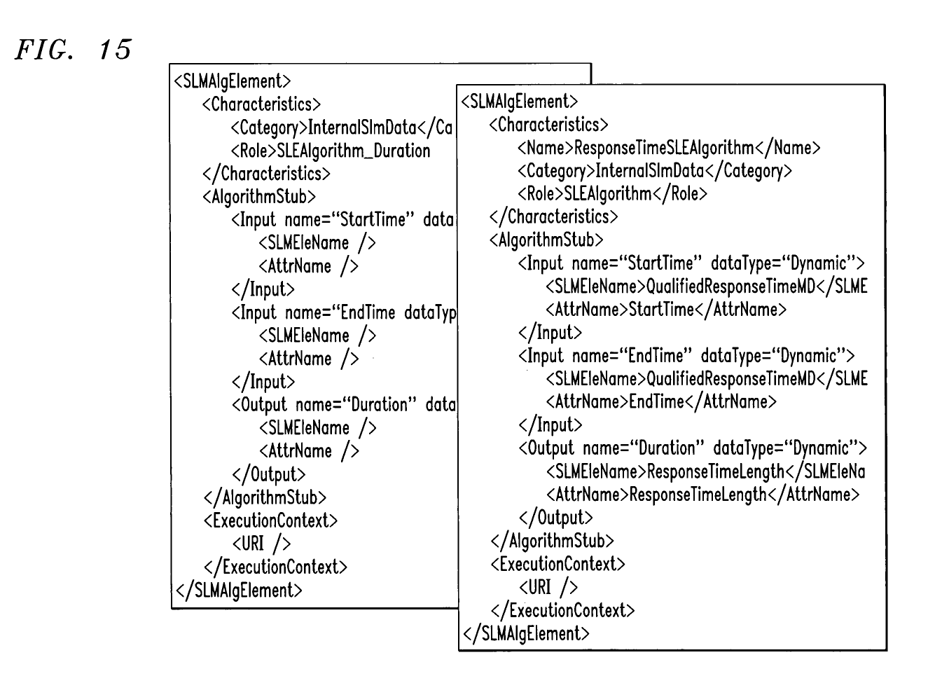

The Application Support Level 406 provides a higher level of functionality (e.g., “richer” data management access capabilities, as described later). One module in the Application Support Level is the Flow Data Execution module 406-A (described below more fully in the context of FIG. 12A and FIG. 12B), which is responsible for selecting (and optionally applying) an algorithm to a set of data based on the relationship mapping and templates in a manner described below. The second module shown is a Provisioning Template Management module 406-B (described below more fully in the context of FIG. 13), which is responsible for creating a new contract “instance” based on an offering template and for incrementally populating this instance based on template based updates.

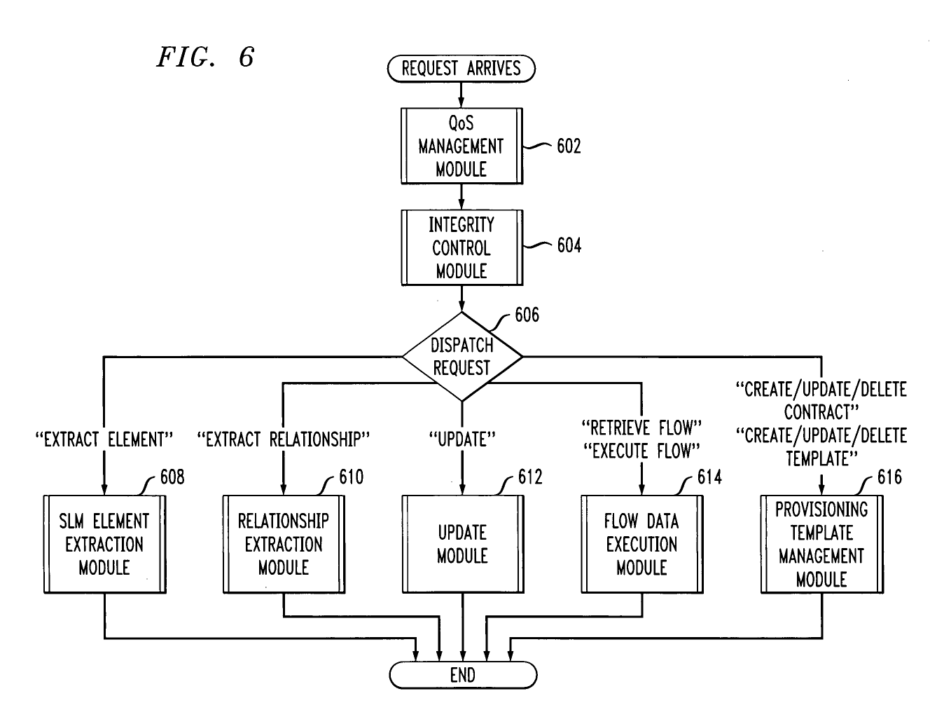

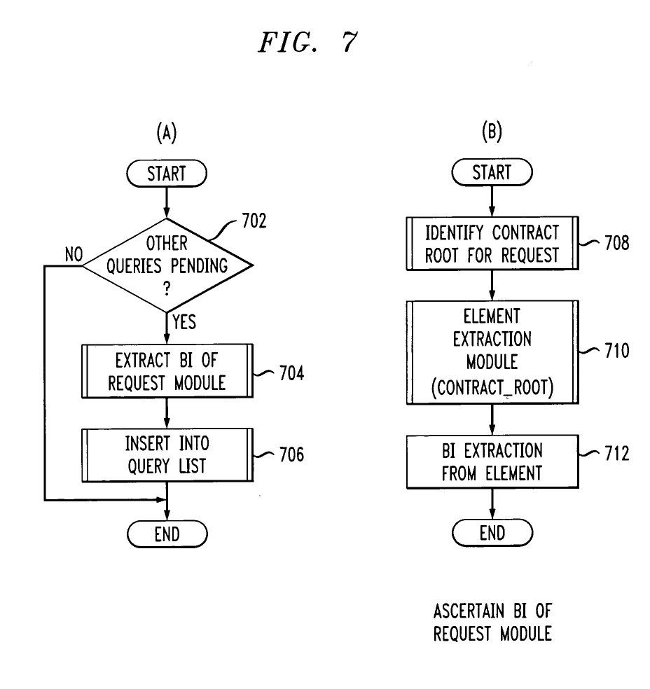

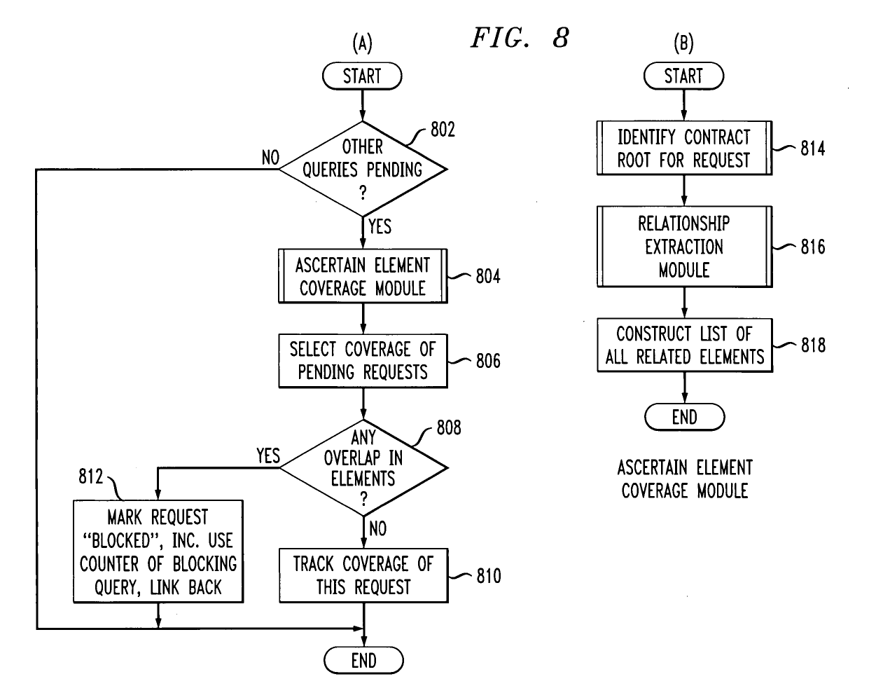

The Application Support Level modules may be considered “users” of the Lower Level modules. The left region of the right-side of FIG. 4 illustrates common SLA Data Management System APIs (application programming interface), referred to a Font End 408. The APIs may be either in XML, Java Classes or some alternate embodiment; XML is shown. The Front End is responsible for coordinating requests (using the Integrity Control module, described below more fully in the context of FIGS. 8A and 8B) and includes a QoS Management module to prioritize data store access requests based on their perceived business impact (described below more fully in the context of FIGS. 7A and 7B).

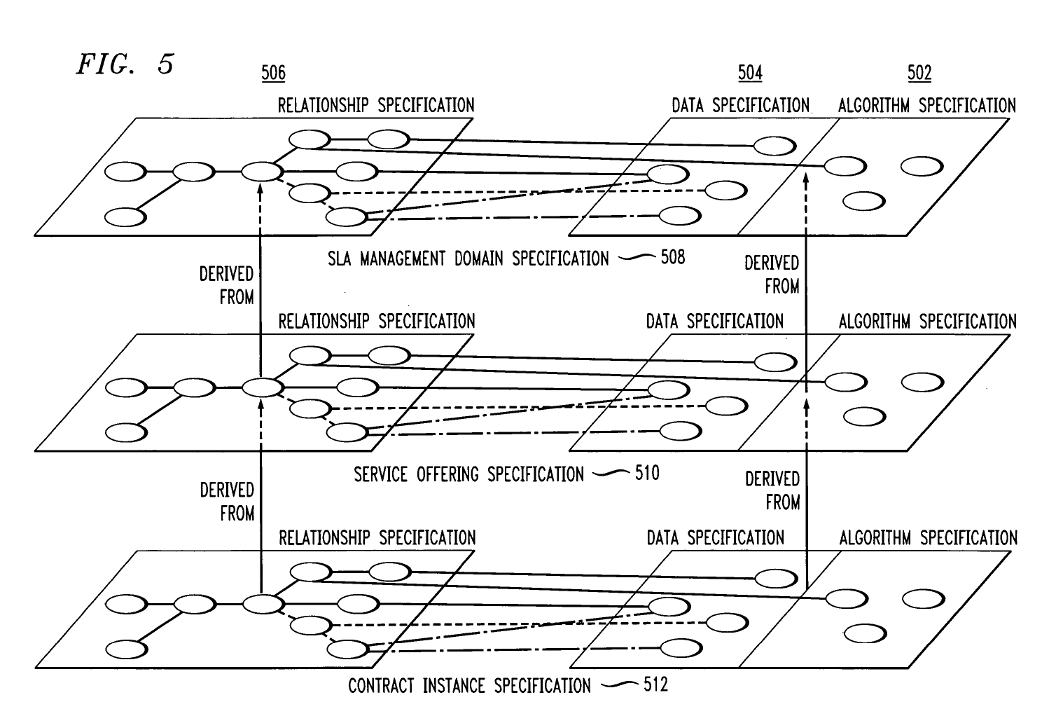

FIG. 5 illustrates an embodiment of a data model associated with the static SLM data within data store 402 (FIG. 4). The data model is designed to capture the essential SLM relationships per the description above. The model shows that algorithm specifications 502, data specifications 504 and relationship specifications 506 are represented within the data store. The model also describes notionally that there are SLA Management Domain Specifications 508, Service Offering Specifications 510 and Contract Instance Specifications 512.

Service Offering Specifications are derived from SLA Management Domain Specifications, and Contract Instance Specifications are derived from Service Offering Specifications The SLA Management Domain Specification may be thought of as the “universe of discourse” for SLA Management, in that template representations of all elements available in an offering (all SLM data) are represented in its specification. Relationship, data and algorithm specifications templates may be refined based on hierarchy using the characteristic the the data elements as described below. The Service Offering Specification is the template based representation of a particular Service Offering. The Offering Elements are derived from the SLA Management Domain Specification in that they are refinements of them with additional offering specific details. The Contract Instance Specification is the representation of the SLM data/relationships in support of a particular SLA contract. The instance is derived from the Service Offering Specification in that it further refines the data elements such that a particular contract instance is supported (assigned to SLM resources).

In general, there is a 1 . . . N cardinality between the specification levels (there may be many Contract Instances based on a given Service Offering, etc.) The straight connecting lines on the figure illustrate three of the primary relationship types that are represented in the relationship specification. The solid lines illustrate “orchestrations” and “processing relationships” in support of SAM relevant processing including service level attainment computations and business impact analysis. The dashed lines illustrate “schema” relationships which link together selected data elements based on relational type schema. The dashed/dotted lines illustrate “SLA/SLM data elements” which link together SLA contract and corresponding SLM data for particular SLM elements. The representation of these relationships and the way in which they are used in support of the management system, which makes use of it, forms a part of the invention described.

3. Data Request Processing

With reference now to FIG. 6, data requests (insertion/retrieval/update) are received from an external application (as illustrated by 401 of FIG. 4) and are processed as illustrated in the flow graph of FIG. 6 in accordance with an embodiment of the present invention.

The data request (represented in some appropriate description language such as XML) is received by the data management framework and is passed to the QoS Management module (step 602) which is responsible for establishing the ordering of requests (based on quality of service) to be processed, should multiple requests be concurrently pending. Additional details on step 602 are provided below in the context of FIGS. 7A and 7B.

In deference to the request reordering that takes place in step 602, the data is then passed to the Integrity Control module (step 604) which is responsible for ensuring the data request will not be corrupted by other pending data requests and in turn will not corrupt other pending data requests. Additional details on step 604 are provided below in the context of FIGS. 8A and 8B.

In deference to the request reordering/waiting that takes place in step 604, the data request is then checked for the nature of the request and a selection is made from one of five modules, if the request is “extract element” then SLM Extraction module (step 608) is called, if the request is “extract relationship” then Relationship Extraction module (step 610) is called, if the request is “update” then Update module is called (step 612), if the request is “retrieve (or execute) flow” then Flow Data Execution module (step 614) is called, if the request is “create (or update or delete) contract” or “create (or update or delete) template” then Provisioning Template Management module (step 616) is called.

These modules are responsible for completion of the data request and conclude by returning a result (or error code) to the application. It should be apparent to those skilled in the art that the particulars of the requests will vary depending on the precise nature and that not all request details can be enumerated here. Likewise, it should be apparent to those skilled in the art that the precise organization of the modules can be modified and augmented with additional functions (as illustrated by the ellipsis in FIG. 4).

With reference now to FIGS. 7A and 7B, the QoS (quality of service) Management module as illustrated in the flow graph of FIGS. 7A and 7B is responsible for establishing the ordering of requests (based on quality of service) to be processed, should multiple requests be concurrently pending. It is also noted without loss of generality that this step is entirely optional and in no way impedes the remainder of the invention. It is also noted that the opportunity that is presented by the QoS Management module is made available by virtue of the nature of the data that is being processed namely Service Level Management data and associated business impact.

The following data flow illustrates but one of many possible embodiments that serve to satisfy the objectives. Those skilled in the art will recognize that many alternate approaches are also possible. The data request is received by the QoS Management module and, in step 702, a check is made to see if other queries are pending. If no other queries are pending, this query should be handled immediately and the module returns to step 604 (FIG. 6).

If other queries are pending, then step 704 (Ascertain Business Impact (BI) of Request Module) is taken. Once the BI has been ascertained via this module, the query can be inserted into the list of pending queries based on the exposed business impact of the contract to which it pertains as compared with the BI's of the other pending queries, as indicated in step 706. We note that other more elaborate algorithms may be used.

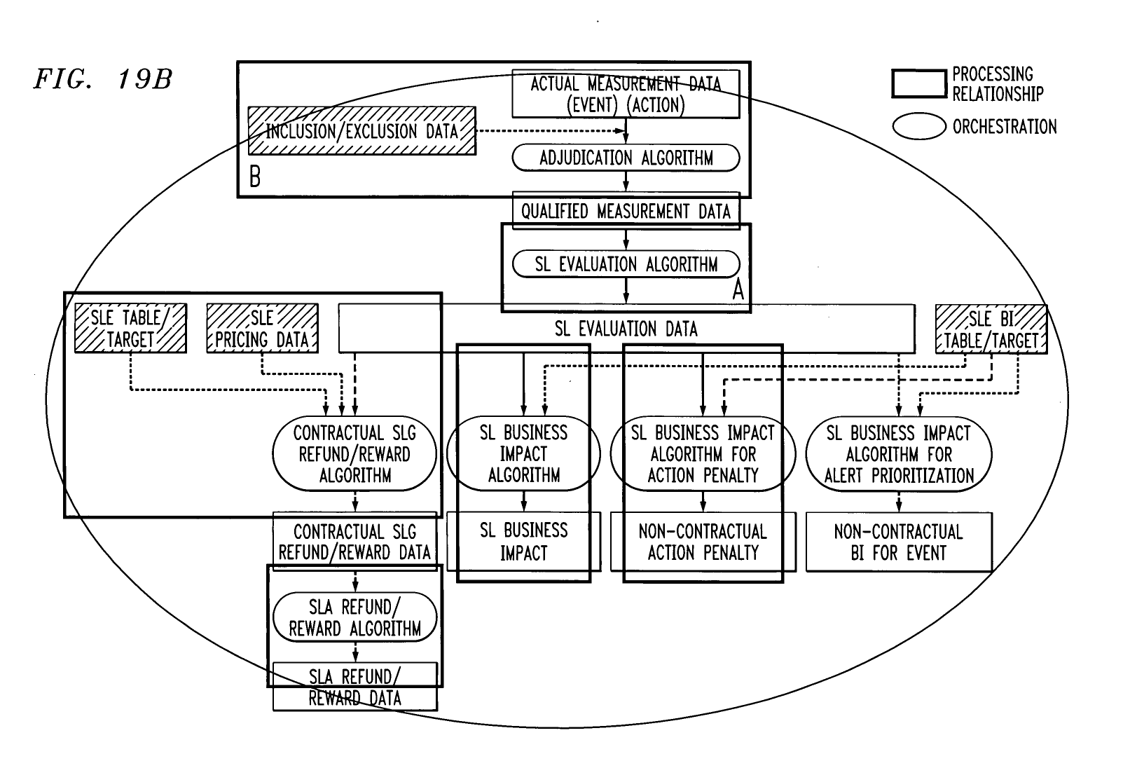

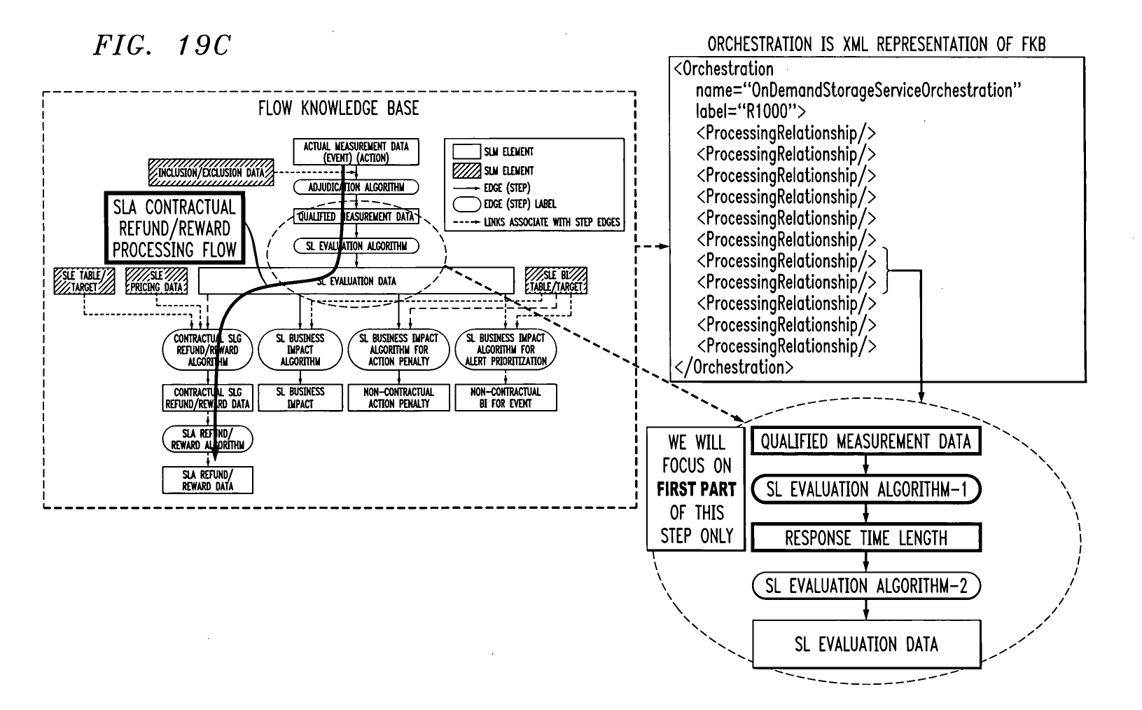

One embodiment for step 704 proceeds as follows (FIG. 7B). In step 708, the contract root of the data request is ascertained by an appropriate query (see below for explanation of FIG. 9) to the contract root for the SLM Elements referenced. Once the contract root is located, the SLM Element for the contract root is extracted (step 710). The month-to-date business impact may be extracted as a field of the SLA Refund/Reward data referenced from the data flow graph for the contract in question which is readily available from the SLMDataElement for the SLARefundRewardData (see FIG. 19A). In step 712, BI extraction from Element is then responsible for extracting this value for use by the QoS Management module.

It will be recognized by those skilled in the art that this flow is readily optimized by the use of caches to store the current values of the exposed business impact for each contract and the use of inverted lists to map SLM Elements to these values resulting in very efficient lookups which will not degrade the performance of the system.

With reference now to FIGS. 8A and 8B, the Integrity Control module as illustrated in the flow graph of FIGS. 8A and 8B is responsible for ensuring the data request will not be corrupted by other pending data requests and in turn will not corrupt other pending data requests. It is noted without loss of generality that this step is entirely optional and in no way impedes the remainder of the invention. Should the module be omitted, it shall be the responsibility of the applications to make use of locks and other such software coordinate capabilities to ensure that the data request will not corrupt other pending data requests.

The following data flow illustrates but one of many possible embodiments that serve to satisfy the objectives. In this embodiment, a check is made against the coverage of the SLM elements that are referenced in this data request as opposed to other requests. If there is overlap then there is the potential for corruption and the two requests cannot safely be executed together. Those skilled in the art will recognize that many alternate approaches are also possible.

The data request is received by the Integrity Constraint module and, in step 802, a check is made to ascertain if other queries are pending. If no other queries are pending, there can be no corruption of data from other pending requests and the model returns to step 604 (FIG. 6). If other queries are pending, then step 804 (Ascertain Element Coverage module) is taken. Once the element coverage for this request is identified, this can be compared against similar lists extracted during step 806 (Select Coverage for Pending Requests). A comparison is made, in step 808, to see if there are overlaps between the sets of lists (SLM ids). If there are overlaps, step 810 is taken, otherwise step 812 is taken.

In step 810, the request map for this request is recorded for tracking against other future requests and the module completes. In step 812, there is an overlap and this request is marked “blocked” with a reference of all requests with which it overlaps. The request is marked “unblocked” when the other pending requests with which it overlaps complete.

The Ascertain Element Coverage module (step 804) is further described in the context of FIG. 8B. In step 814, the contract root for the request is identified. This involves locating the contract root(s) for the SLM Elements identified in the data request. Then, in step 816, the Relationship Extraction module is executed which extracts the relevant relationship information for the SLM Elements in question. These relationship trees are parsed to build a list of all SLM elements for a given contract, in step 818.

It will be recognized by those skilled in the art that this flow is readily optimized by the use of caches to store the coverage maps for requests and the use of inverted lists to map SLM Elements to these values resulting in very efficient lookups, in a manner similar to that for QoS Management, which will not degrade the performance of the system.

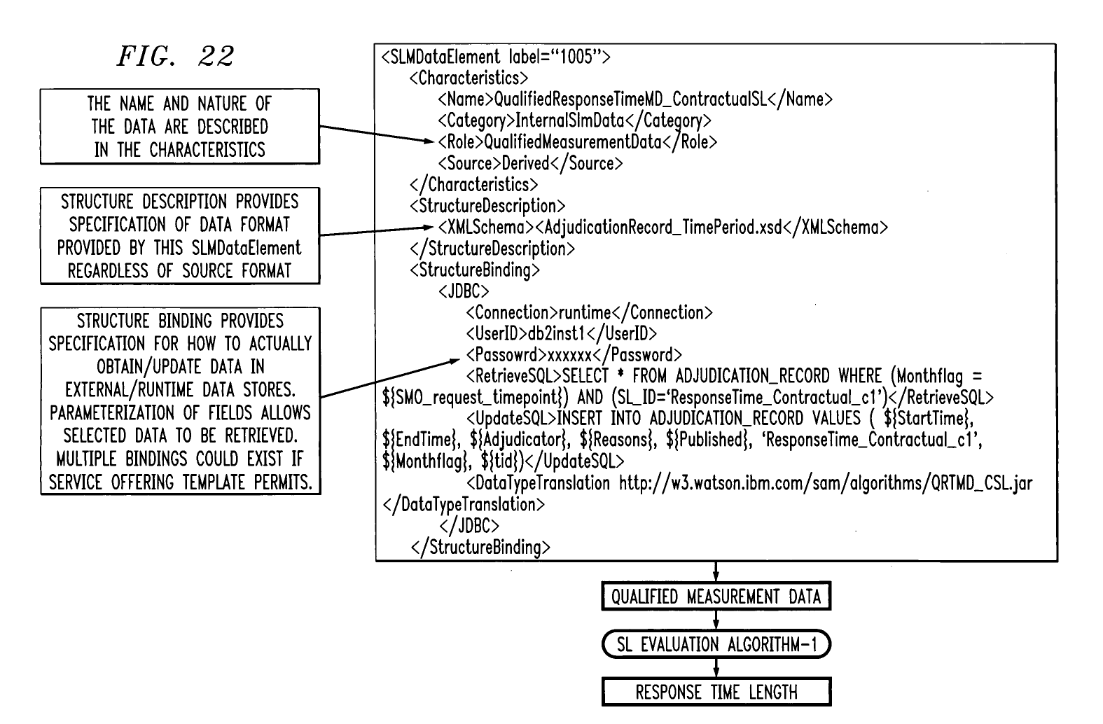

With reference now to FIG. 9, the SLM Element Extraction module as illustrated in the flow graph of FIG. 9 is responsible for permitting the extraction of one or more SLM elements (data or algorithm elements) as selected by the search criteria specified in the data request. The received data request is first mapped into an appropriate data store query assignment (step 902) which, for XML, would be an XQuery statement and for a relational data base would be an SQL (Structured Query Language) query. The exact nature of the query will be determined based on the nature of the data to be extracted, however, as shown in FIGS. 22, 24A, 24B, 24C and 25, the principal characteristics of the SLM data elements are readily available to be queried against.

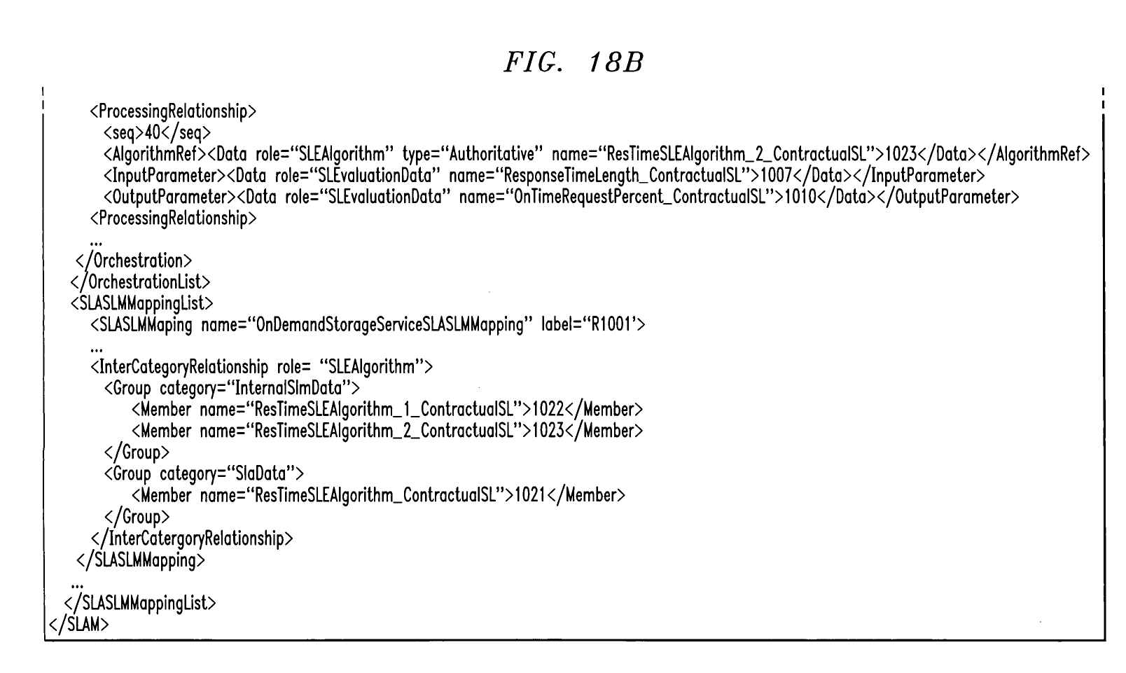

For example, a data request to access the “contract root” label of the SLM data element for the contract whose name is “OnDemandStorageService_CompanyABC” would be accommodated using the XQuery to select the XML Element where the element is indeed an SLMDataElement, the role (one of the characteristics) is “ContractRoot”, the StructureDescription defines a “ContractName” element which is represented in the StructureBinding (in a manner similar to the contract instance of FIG. 17) which is the fixed string “OnDemandStorageService_CompanyABC”. This is accomplished in XQuery using the following query:
for $b in ./DataSpecList/SLMDataElement where
for $b in ./Characteristics/Role/text( )=“ContractRoot” and $b/StructureBinding//ContractName/text( )=“OnDemandStorageService_CompanyABC”} return <result> {string($b/label)} </result>

It should be apparent to those skilled in the art that a great multiplicity of differing queries may be enacted against the data store for a variety of different needs. Some of these will become apparent from their application in other modules.

Once the appropriate query has been composed, the query is passed to the XML data store for Xquery Datastore Access (step 904). The query is then compared against the data store and the relevant SLM Element(s) that match are retrieved and formatted in accordance with the XQuery statement. A test is made (step 906) to determine whether that data specification (SLM Element) is requested (step 908) or the underlying data (step 910) is requested. If the data specification is requested (step 908) then no further processing is required. It is assumed that the XQuery result has properly extracted the data requested (e.g., return {string($b)} for the SLM element above) which is then returned to the application. If the actual data corresponding to a data specification is requested, then the result set is retrieved through Result Set Retrieval (step 910) by extracting the Structure Binding (as illustrated in FIG. 22), populating the unbound variables in the query with values passed by the application, and issuing the query on the data store that is referenced according to the query.

To use the example in FIG. 22, the Structure Binding provides connection information to a database and a retrieval and update query as follows:

<RetrieveSQL>SELECT * FROM ADJUDICATION_RECORD
WHERE ( Monthflag =
${SMO_request_timepoint}) AND
(SL_ID=‘ResponseTime_Contractual_c1’)</RetrieveSQL>

<UpdateSQL>INSERT INTO ADJUDICATION_RECORD
VALUES (

${StartTime}, ${EndTime}, ${Adjudicator}, ${Reasons},
${Published},‘ResponseTime_Contractual_c1’, ${Monthflag},
${tid})</UpdateSQL>

In this case the values for ${SMO_request_timepoint}, etc., are replaced with values passed in with the application data request and the statement is executed against the target runtime database within 402 of FIG. 4. It should be apparent to those skilled in the art that a great multiplicity of formats may be used for the queries, and that XML or relational data stores can, in principal, be accessed.

Step 912 allows for a Result Set Transformation in that the returned data must comply with the format as described in the Structure Definition (as illustrated in FIG. 22). Details of the data format are described in accordance with the description syntax, for example, FIG. 22 references an XML schema representation of the format (“AdjudicationRecord_TimePeriod.xsd”). Other description syntaxes may be used. The Result Set Transformation may be the location of an XSLT (Extensible Stylesheet Language Transformations) script in the case of XML or some other transformation script (e.g., Perl, etc.). It should be apparent to those skilled in the art that there are many such transformation languages. Once the result data has been transformed into a format compliant with the Structure Description, the data is returned to the application in step 914 (Data Return). This concludes one embodiment of SLM Element extraction. Those skilled in the art will recognize there are many alternatives that are essentially similar in nature.

With reference now to FIGS. 10A and 10B, the SLM Relationship Extraction module as illustrated in the flow graph of FIGS. 10A and 10B is responsible for providing to the application the relationships that are presently defined for a particular SLM Element. The application data request is used to request a Get Contract Root (step 1002) by the appropriate XQuery statement. For example, if the SLM Relationships for the contract labeled “OnDemandStorageService_CompanyABC” are required, then that XQuery of the previous paragraph may be used. If other selection criteria are to be used, then the query may be modified accordingly.

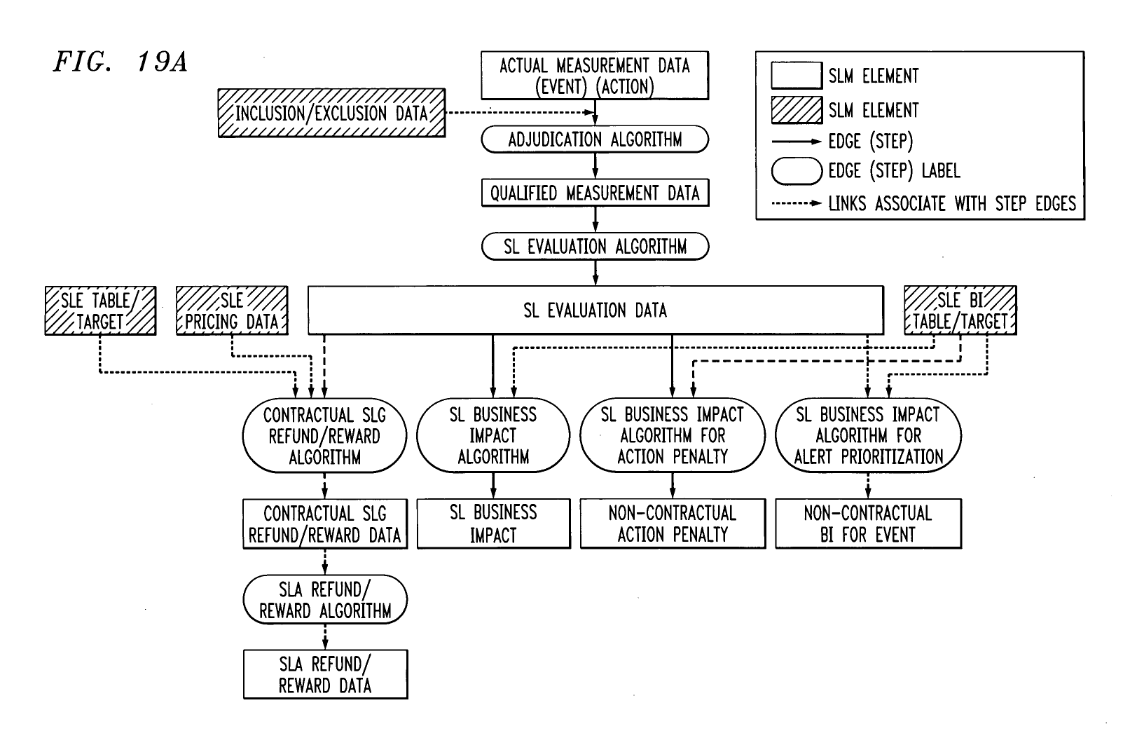

Once the contract root for the applicable SLM element has been located, other contract relevant relationships may be extracted. In this embodiment, a Hash Map (a data structure that relates key, value pairs) is created of all the elements associated with the contract by Create Hash Map for Contract Relationships (step 1004). This step may be performed once for each contract and is easily accomplished by traversing the three relationship type structures as illustrated in FIG. 18. For a particular contract, three types of relationships are presently maintained: Processing Relationships, SLA/SLM Mapping Relationships and Schema Relationships. These are all accessible given the contract root.

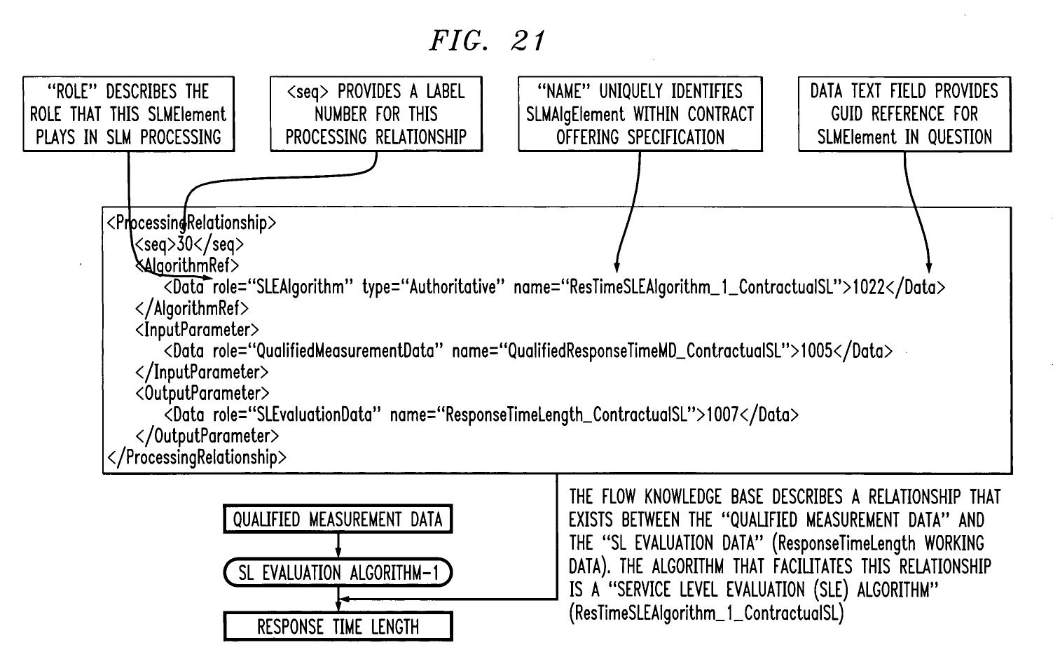

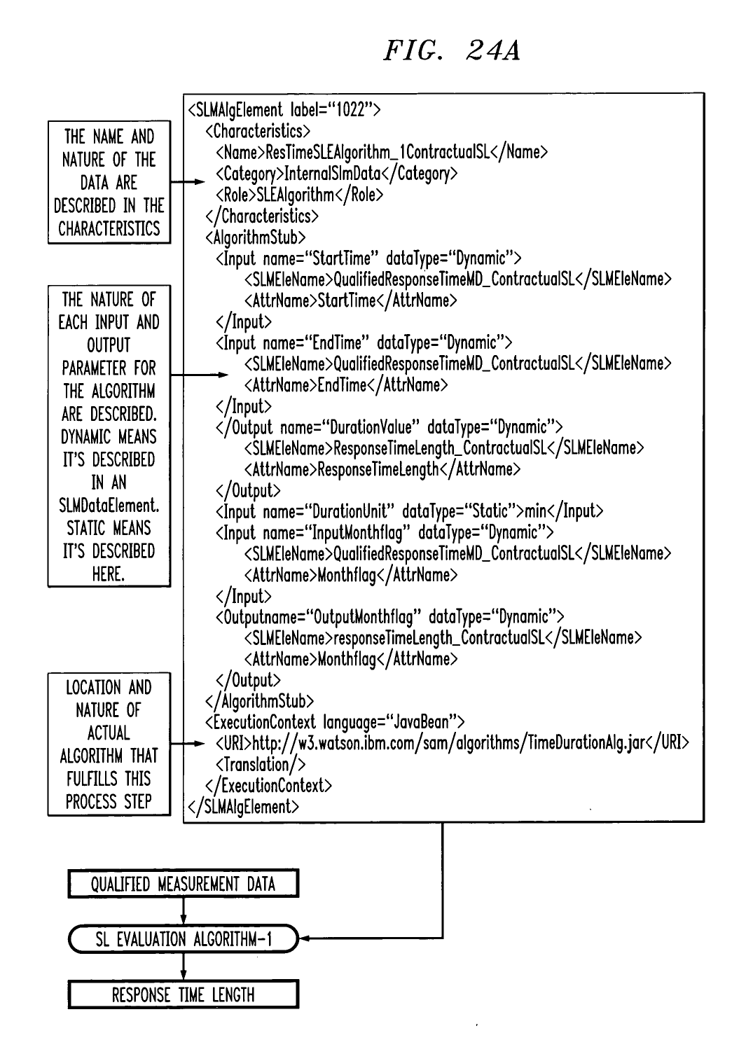

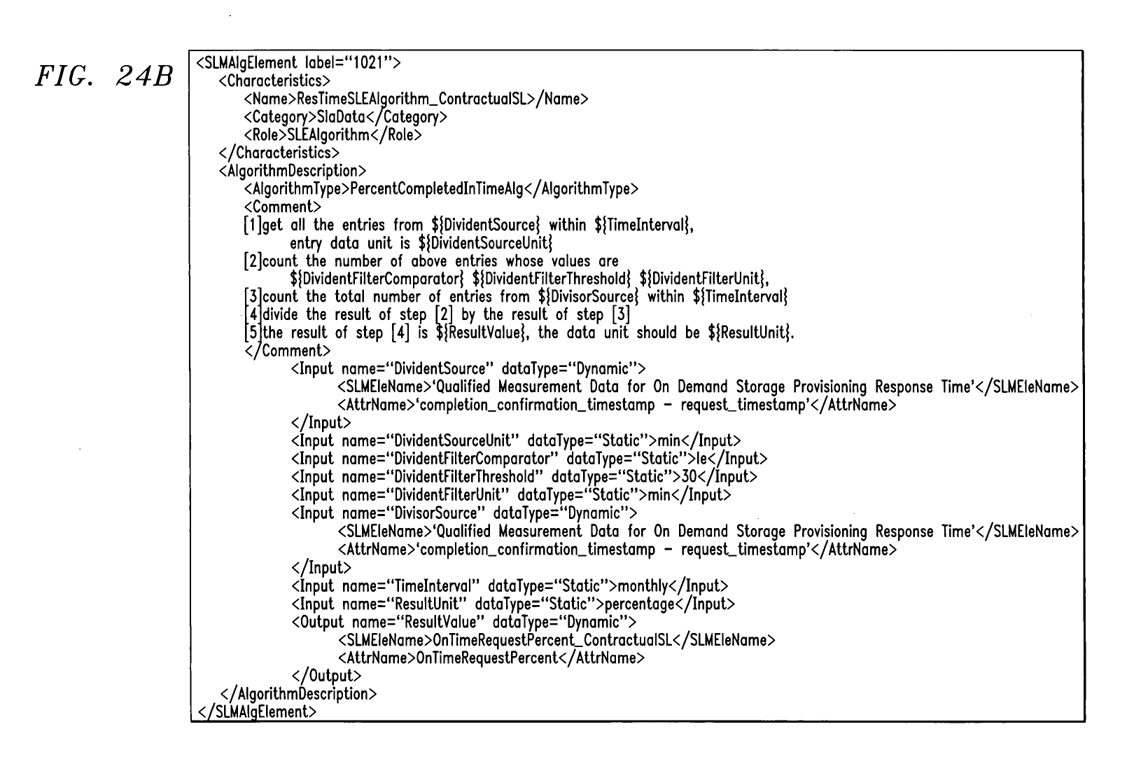

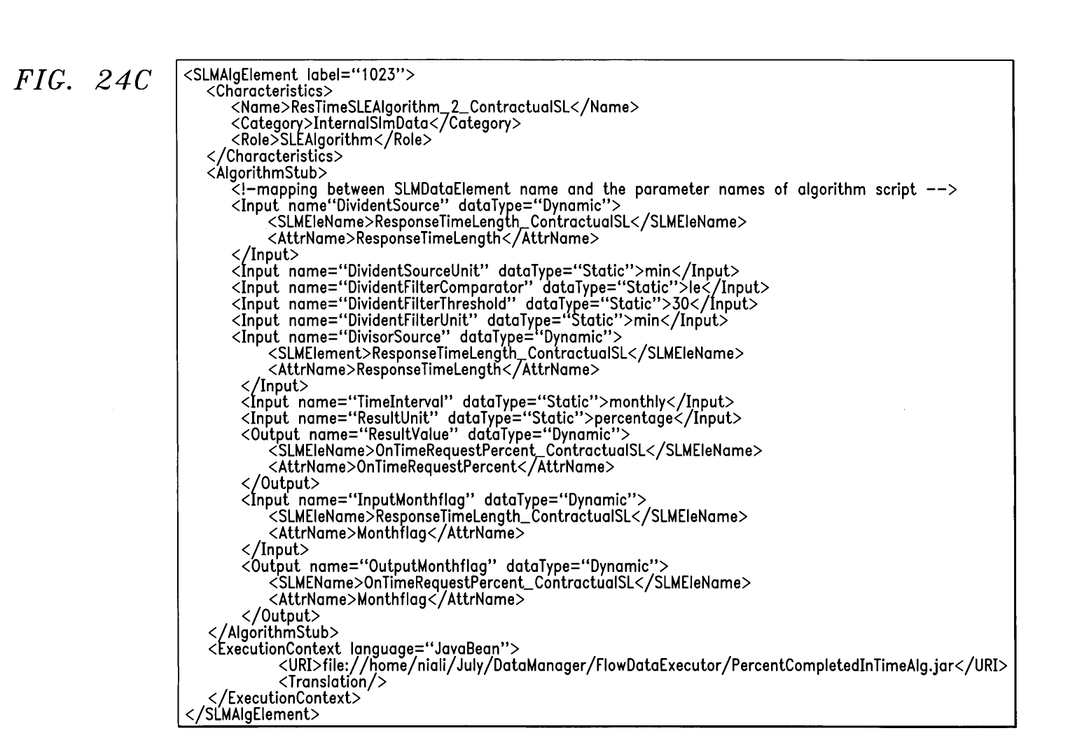

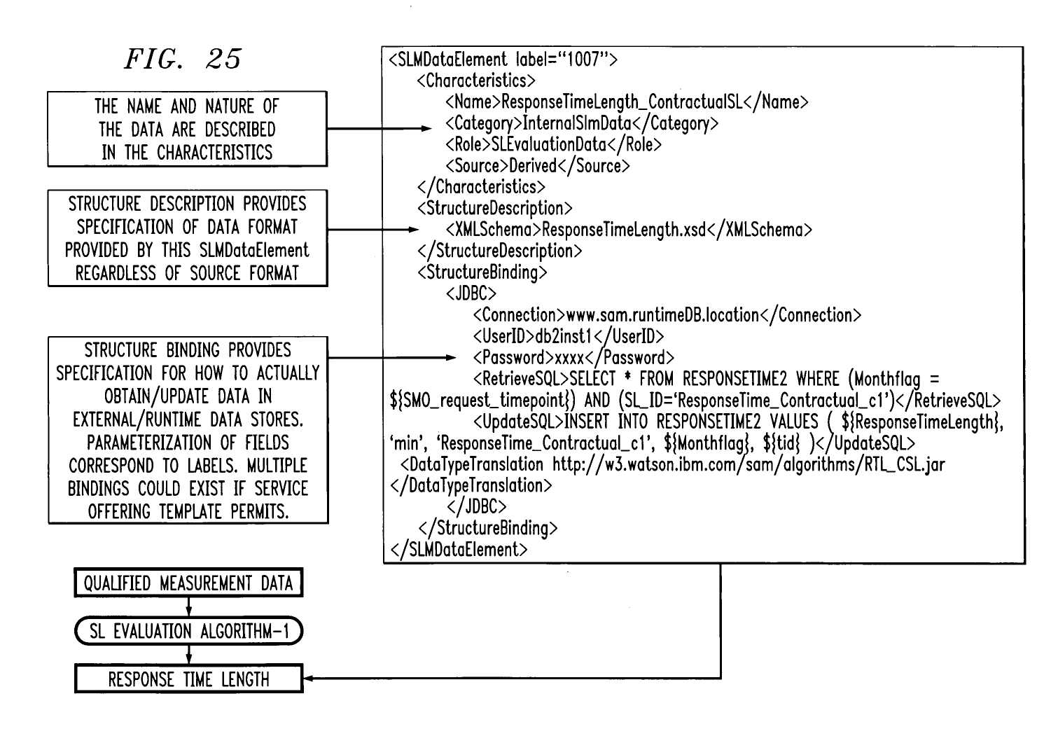

FIG. 18 provides a representative sample of these relationships for a particular contract instance (i.e., form the “RelationshipSpecification” in the “Contract Instance Specification” of FIG. 5). Although not shown here, this Contract Instance Relationship Specification is derived from a Service Offering Relationship Specification which defines the relationship template without ascribing the contract instance labels. For the particular illustrative contract instance:
The <SchemaRelationship> provides an explicit representation of the non-flow graph processing related schema to be maintained for this contract. Each <SchemaRelationship> indicates how a particular SLMDataElement (the <CentralData> element, e.g. ContractRoot) is related to other SLMDataElements using <LinkData> elements based on the role, category and names of the SLMDataElements. Additionally for the ContractRoot <SchemaRelationship> (only) there are linkages using the <LinkRelation> element to the data-flow processing relationships (i.e. the <OrchestrationList>) and the SLA/SLM Mapping relationships (i.e the <SLASLMMappingList>).
The <Orchestration> provides an explicit representation of the data-flow processing relationships that are supported for this contract (e.g., processing relationships that are associated with SLA reporting, SL related business impact assessment etc.) Each <Orchestration> defines a flow graph of computation steps (<ProcessingRelationship>'s) which define the nature of data associations including their inputs and result sets as distinguished by the role and name characteristics. Notice that <ProcessingRelationship> with <seq> 30 in FIG. 18 binds the <AlgorithmRef> 1022 with its input parameters and output parameters described in SLMDataElements 1005 (FIG. 22) and 1007 (FIG. 25) respectively. Additional details regarding Orchestrations and Processing Relationships is provided in FIGS. 19A, 19B, 19C, 21 and the accompanying text.
The <SLMSLMMapping> provides an explicit representation of the associations between SLA contract data SLMElements (both Data and Alg) and the corresponding internal management SLM SLMElements. Each <SLASLMMapping> element is composed of a set of <InterCategoryRelationship> elements that associate particular SLA contract data with SLM data. An example of this correspondence is provided between FIGS. 24A, 24B and 24C which shows how the SLA contract specification of the algorithm (FIG. 24B) is related to the InternalSLMData for the algorithm (FIGS. 24A and 24C).

For example, given the contract root label, the following query may be used to extract the layer three schema relationships for a particular element from the XML data store:
for $b in ./SLAM/SchemaRelationshipList where
{$b/SchemaRelationship/CentralData/text( )=<label retrieved from above>} return $b

The Hash Map will then contain pairs of {SLM Element, Linked SLM Element} whereby an entry in the Hash Map indicates that the two SLM Elements are linked by a schema relationship. Other relationship types (Processing and SLA/SLM) can be likewise extracted by following the LinkRelations from the SchemaRelationship for the contractRoot element.

Once the Hash Map has been constructed, the relationships for a particular element may be easily extracted by generating the transitive closure over the relationships for the element in question. This may be achieved by Get Elements Related to Label (step 1006) as detailed in FIG. 10B. In step 1008, “links” is assumed to be a set of links that the SLM element in question is related to, “label” is set to the label of the SLM element in question. In step 1010, a check is made to see if there are no labels to process. If there are no labels then step 1016 is executed, otherwise step 1012 is followed. If there are no more labels to consider, then for each SLM element in the list, the Relationship is retrieved and reported back in step 1022 (Relationship Return).

If the label is not null, there are still SLM relationships to identify. Get Elements Related to Label Step (step 1012) retrieves all the relationships for the current label as recorded in the SLM relationships. If the result set is null, then step 1014 is executed, otherwise there was a relationship identified (step 1024). If there was a relationship identified, then the result set is compared with the existing links (step 1024) in the label set. For each relationship not already in the list of links, the label in question is included (step 1020) and the process proceeds to step 1014.

In step 1014, the process assigns a label to the next label in the label set and again seeks to find all the labels that correspond thereto. It should be apparent to those skilled in the art that many other relationships can be extracted by appropriate constraints on the nature of the requests, in particular (but without limitations), Schema relationships, processing relationships, SLA/SLM relationships, transitive closures, etc. This capability comes from the explicit representation of relationships at that instance level within the data store, recognizing that relationships will vary between contract templates and between contract instances.

With reference now to FIG. 11, the Update module as illustrated in the flow graph of FIG. 11 is responsible for updating one or more SLM elements (data or algorithm elements) and or relationships as selected by the search criteria specified in the data request. Inclusion of an Update module in the extensible framework permits certain integrity checks be made in the case of updates and provides a layer of abstraction between the users requests and the actual data.

In step 1102, a query assignment is made (e.g., construction of an XQuery statement in the manner described above in step 902 (FIG. 9). In step 1104, the datastore is accessed based on the query and, in step 1106, the relevant SLMData/AlgElements are retrieved. The changes to these SLM elements are made in step 1108 in accordance with the values provided in the data request and in accordance with any integrity checks that are required for updates. Finally, in step 1110, the results are written back to the store.

With reference now to FIG. 12A, the Flow Data Execution module as illustrated in the flow graph of FIG. 12A is responsible for permitting the extraction (and, optionally, the execution) of a processing flow as selected by the search criteria specified in the data request. That is, the module permits the extraction of either the data specifications (SLM Elements), the data described in the specifications, or the results of application of the algorithms to the data, depending on the user's request.

A flow data extraction request data applies to a particular contract and as such the first step in such a request is the Extract SLM Element (for the ContractRoot) as identified in step 1202. Once the contract root has been accessed, the relevant Relationship information is readily available as illustrated in FIG. 19C and is extracted as identified in step 1204.

There are multiplicities of ways in which the relationship information may be used by applications. In broad terms, the processing relationships describe a connected directed graph of legitimate processing sequences based on the requirements of the SLM management system. This graph may be traversed “forward” from end results (e.g., SLA refund/rewards) towards the data that was responsible for this result, or traversed “backward” from data sources (e.g., Unqualified Measurement Data) towards the results that the SLM management system provides. Given this, the two uses described herein are the extraction of the SLM Elements Specifications between two endpoints in the flowgraph (“backward” processing from the “role” of the starting point to the “name” of the ending point) and execution, by the data store, of the algorithms along this path. For the purposes of discussion and without loss of generality, it is assumed that the starting point is “role” =“QualifiedMeasurementData” and the ending point is “name” =“ResponseTimeRefundPrice”.

In step 1206, the flow direction is checked and either step 1208 or step 1210 is followed. In step 1208, the Start and End points for the query plan are selected based on forward processing. This leads to step 1212 in which a query plan is constructed as described in FIG. 12B. In step 1210, the Start and End points for the query plan are selected based on backward processing. This leads to step 1214 in which a query plan is constructed as described in FIG. 12B. The result is a query plan of all the SLMAlg/DataElements that are to be used in satisfying the request.

In step 1216, the starting processing relationship is extracted. Given this, the appropriate algorithm specification is extracted in step 1218. In step 1220, the nature of the request is inspected, (either a “data spec” request (step 1222), a “data” request (step 1224), or a “processing” request (step 1226). For a data specification request (step 1222), the relevant SLM Data Elements are extracted as described by the processing relationship in the manner described in FIG. 9. The result set is augmented with these data specifications in step 1228 and the current processing relationship is advanced (in step 1244).

For a data request (step 1224), the relevant SLM Data Elements are extracted as described by the processing relationship in the manner described in FIG. 9. These data specifications are then used to extract the data in a manner as described in FIGS. 21 through 24 (extracting the source data from the appropriate data stores as needed). The result set is augmented with this data in step 1238 and the current processing relationship is advanced (in step 1244).

For a processing request (step 1226), the relevant SLM Data Elements are extracted as described by the processing relationship in the manner described in FIG. 9. These data specifications are then used to extract the data in a manner as described in FIGS. 21 through 24 (extracting the source data from the appropriate data stores as needed, applying the algorithm described in the SLMAlgElement, and writing the results back to the target stores as needed, step 1242). The result set (results of the final processing step and status information) is returned and the current processing relationship is advanced (in step 1244). Step 1246 checks to see if the query plan has been completed. If it has, then the results are returned (step 1248), otherwise the next iteration is started (step 1218).

With reference now to FIG. 12B, the Build Query Plan module as illustrated in the flow graph of FIG. 12B is responsible for identifying a path between the start and end points through the dynamically constructed processing graph. The problem amounts to the well-known problem of finding a path through an acyclic graph between two points. One of many possible embodiments is provided here which is known generally as a “depth first” search of the graph starting at the Start point until the End point is located (or no path is possible). A stack is used to reflect the state of the traversal and a list is used to maintain the current sequence of nodes to be followed in the path.

These data elements along with a current pointer are initialized in step 1250. A test is made to see if the query is a forward query in step 1252. If it is, then step 1254 is taken, otherwise step 1268 is taken.

In step 1254, a check is made to see if the destination node has been reached. If it has, then the list is complete and is returned in step 1264. Otherwise, step 1256 is taken and the processing relationship in the orchestration (see FIG. 19C) that has the correct input name is located and the set of output names are returned. The result set is checked to see if there were outputs (step 1258) and if so, in step 1260, the current link is removed from the list, the stack is popped to consider a new processing relationship, and the list is augmented with this reference, returning to step 1254. If there were additional outputs, these need to be considered (step 1262). For each processing relationship returned, the stack is pushed with its reference. Then to advance the stack is popped, and the current link is updated to point to this and the link is likewise updated, returning to step 1254.

In a similar manner, if the query is backward, in step 1268, a check is made to see if the destination node has been reached. If it has, then the list is complete and is returned in step 1278. Otherwise, step 1270 is taken and the processing relationship in the orchestration (see FIG. 19C) that has the correct input name is located and the set of input names are returned. The result set is checked to see if there were inputs (step 1272) and if so, in step 1274, the current link is removed from the list, the stack is popped to consider a new processing relationship, and the list is augmented with this reference, returning to step 1268.

If there were additional outputs, these need to be considered (step 1276). For each processing relationship returned, the stack is pushed with its reference. Then to advance, the stack is popped, and the current link is updated to point to this and the link is likewise updated, returning to step 1268.

The result is a query plan comprising of a list of processing relationships required to satisfy the query plan.

With reference now to FIG. 13, the Provisioning Template module as illustrated in the flow graph of FIG. 13 is responsible for creating/updating/deleting both contract instances and contract templates (contract offerings) as selected by criteria specified in the data request.

Receipt of an application data request is dispatched by the Dispatch Request (step 1302) depending on the nature of the request. For the embodiment described herein, six cases are considered: Create Contract Instance module (step 1304), Update Contact Instance module (step 1306), Delete Contract Instance module (step 1308), Create Contract Template module (step 1310), Update Contract Template module (step 1312), and Delete Contract Template module (step 1314).

In the case of Create Contract Instance module (step 1304), the relevant contract template is identified in accordance with the appropriate search criteria on the Service Offering Specification level as described above in the context of FIG. 5. For example, the contract template may be identified by searching for the set of SLMDataElements enclosed by the DataSpec element whose utility is service level action management (util=“SLAM”) and whose contract group is for the relevant service (contractGroup =“OnDemandStorageService”). That is, within the Service Offering Specification database, the following structure will reside:

<DataSpec util=“SLAM” contractGroup=“OnDemandStorageService”>
<SLMDataElement> ... </SLMDataElement>
<SLMDataElement> ... </SLMDataElement>
...
</DataSpec>

This is sufficient to locate all the SLM Data/Alg Elements for this Service Offering and hence also the relationships (by using same keys). That is, within the Service Offering Specification database, the following structure will reside:

<RelationSpec util = “SLAM”
contractGroup=“OnDemandStorageService>
<SchemaRelationshipList>
<SchemaRelationship> ... </SchemaRelationship>
...
</SchemaRelationshipList>
</RelationSpec>

Once a template has been selected, the contract instance database is populated with a copy of the template with additional information filled in as required. Fields that are to be completed when the template is created are indicated within the template by a designated flag, e.g., ‘???’, other fields will be a pre-filled part of the template. As the instance SLM Elements are created, the label fields are filled in with unique IDs and the relationships elements are filled in with the appropriate element references to the SLM Elements.

In the case of Update Contract Instance module (step 1306), a contract instance is to be updated in accordance with a set of SLM Elements provided as one of the relationships within the RelationshipSpec. One of the types of relationship is TemplateSet, that is:

<RelationshipSpec>
...
<TemplateSetRelationship>
<TemplateSet label=“R001”>
<SLMElementName>ActualReponseTimeMD_NonContractualSL</SLMElementName>
<SLMElementName>...</SLMelementName>
...
</TemplateSet>
...
</TemplateSetRelationship>
...
</RelationshipSpec>

Each TemplateSet is uniquely identified and contains an ordered list of SLMElementLabel or SLMData/AlgElement elements that must be populated. If an SLMElementLabel is provided, it references a named SLMElement to be populated. A single TemplateSet is presumed to be populated by an application in one step. Population of the entire Contract Instance may be effected by completing all the templates in the Template Set.

In the case of Delete Contract Instance module (step 1308), it is sufficient to delete all SLMData/Alg Elements and relationships referenced from a particular contract root to affect the deletion of the contract. It should be noted that for auditing and accounting purposes, deletion of contracts may be done only after a prolonged period.

In the case of Create Contract Template module (step 1310), the application is responsible for the selection and/or construction of appropriate RelationshipSpec and DataSpec entries in the Service Offering database to reflect the demands of the new service to be offered. The SLM Elements used within the new service are drawn from the set of SLM Elements in the SLA Management Domain Specification of FIG. 5. Integrity of the association may be checked by comparison of the nature of the SLM Data/Alg Elements, e.g., inspection of their characteristics and comparison with the Ontology Data, which is also maintained as Relationship data. The construction of a new service that differs significantly from existing services requires careful planning by the delivery center personnel from the viewpoint of new SLA Data/Alg Elements, and relationships.

In the case of Update Contract Template module (step 1312), the application is responsible for the update of appropriate RelationshipSpec and DataSpec entries in a manner to accommodate the changes to the service. Any contracts that are instances of the Template, and are to be likewise revised, require individual modification of their instance data.

In the case of Delete Contract Template module (step 1314), it is sufficient to simply not use the contract template for the creation of new contracts. In the circumstances where the template must actually be deleted, it is necessary to locate and remove the relevant DataSpec and RelationshipSpec along with any contract instances that have been created. This complicated processing requires careful planning by the delivery center personnel.

4. Representation and Management of Data and Relationships

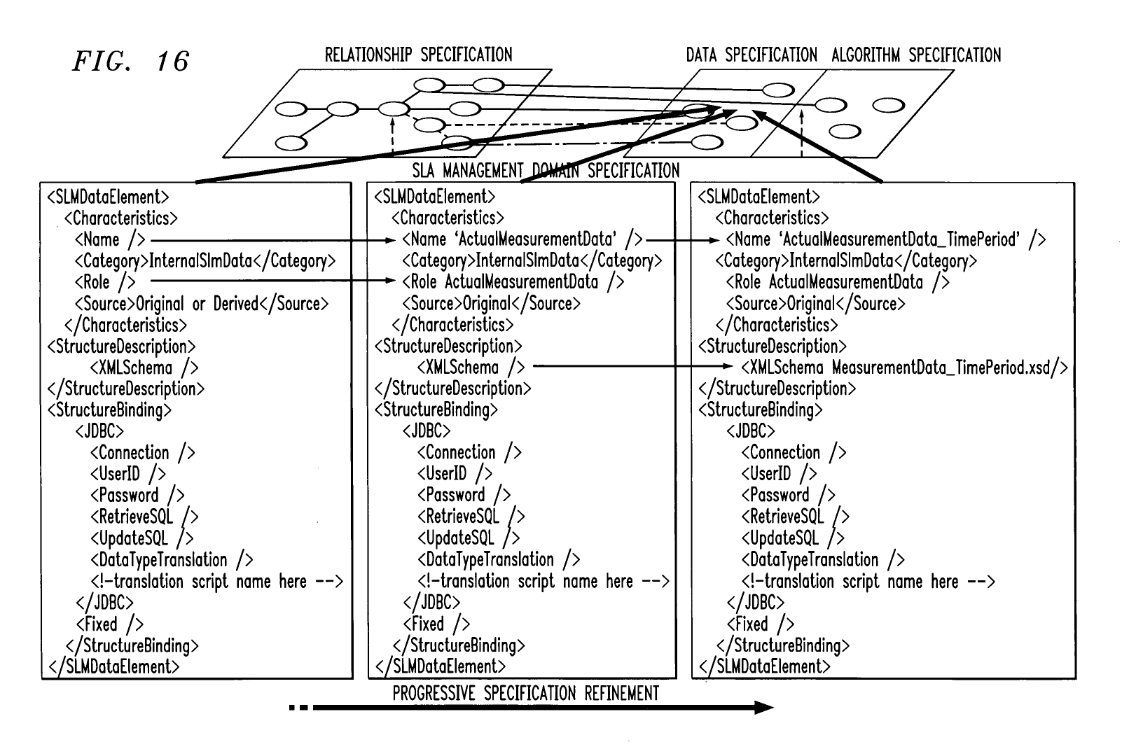

The flow graph-based embodiments described above in the context of FIGS. 6 through 13 may be further understood when viewed in conjunction with the annotations provided in the context of FIGS. 14 through 28.

FIG. 14 illustrates a small example of an SLM Data Element that would reside in the Service Offering Specification and one that would have been derived in the Contract Instance Specification. Notice that the SLMDataElement is comprised of three major sections, a set of Characteristics, a Structure Description, and Structure Binding. The exact syntax (tags) is not critical. The primary sections and the way in which they are used is part of the invention. The Characteristics describe a set of ‘defining characteristics’ that collectively and uniquely describe this element. The characteristics are drawn from a set of orthogonal taxonomies that may be hierarchical in nature and may be parameterized.

The characteristics illustrated here include “name”, “type”, “category” and “role”. The combination of name, type, category and role is sufficient to identify the nature of the element. The table below shows key data fields of the Characteristic part of SLM elements:

| Field | | |
|---|---|---|
| Name | Description | Example |
| Role | The role that current SLM | SLEvaluationAlgorith |
| | element plays within | mQualifiedMeasurement |
| | SLM processes. | Data, etc. |
| Category | Whether current SLM element | SLA data, Internal |
| | reflects a contractual specifi- | SLM data. |
| | cation or a implementation specifi- | |
| | cation in the service delivery center | |
| Type | Data structure of the data specified | MD_Timepoint, |
| | by current SLM element. | MD_TimePeriod, |
| | | MD_Value, etc. |
| Name | Arbitrary name of a SLM element | StorageProvisioningRe- |
| | on Service Offering Specifi- | sponseTimeMD. |
| | cation Level. This is used to | |
| | distinguish two SLM | |
| | elements on service offering | |
| | specification level that have the | |
| | same role, category and type. | |

At the instance level, a “label” is the global unique identifier (a data store GUID). The structure description provides a mechanism for describing the nature of the data that this DataElement refers to. In the example above, an XML Schema is used to describe the data format. The Structure Binding describes how the actual data may be retrieved although the data may be immediately represented as required.

In the example specification of FIG. 14, a JDBC (Java Data Base Connectivity) connection to one of the databases is described. The structure binding may refer to several different locations, any of which provides the “same” data. Notice that the actual “data” may not be “in” the element. The progressive refinement illustrates how the Service Offering Template (which uses a JDBC in the binding) has been populated at the instance specification. Additional levels of refinement are possible based on the extensible hierarchy (not shown).

It is to be appreciated that the above is an illustration of how one of several locations for a piece of data can be referred to. This becomes one of the “characteristics” of the SLMElement (e.g., <Bindings>Authoritative,NonAuthoritative</Bindings>). Thus, in FIG. 14 (instance element 1001), there is only one source for the data (<JDBC> . . . </JDBC>), so the characteristic is dropped. However, in fact, there could be several such “semantically equivalent” sources. Multiple <JDBC> tags would therefore have identifying attributes that match the <Binding> list. The SLMElement specification could use any of these to obtain the data. A XQuery can refine that only one type of binding be used, e.g., authoritative. Notice that each <JDBC> would have its own DataTypeTranslation information since there might be totally different sources. However, the result of the translation is that they all look the same (per the <StructureDescription>) from a result data set point of view. This allows any of the sources to be used as an equivalent source of the data. Thus, advantageously in accordance with the invention there may be several alternate data sources for the same data.

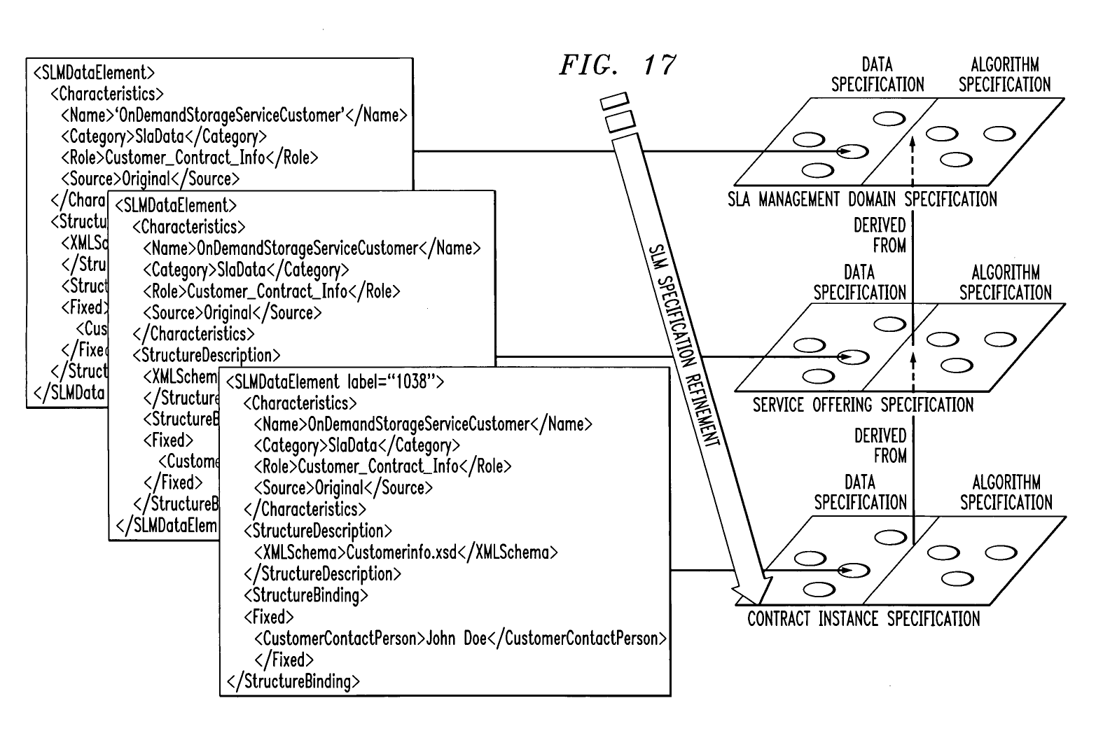

FIG. 15 provides a sample of an SLMAlgElement at both the Service Offering Specification and the Contract Instance Specification. Notice that the algorithm specification is again in three regions: the Characteristics, the Algorithm Stub and the Execution Context. The Algorithm Specification refers to the nature of the algorithm (as described by the characteristics) and the nature of the parameters that it can receive/generate and forms part of the invention.

Notice that as with the SLMDataElement Specification, the actual “algorithm” is not “in” the element. Rather it is referenced by the element. The names of the elements as defined in the Algorithm Stub provide a mapping between the SLM element names and input parameter sets to the algorithm. The Execution Context provides a reference to the actual algorithm code, location and nature. It also provides a mechanism by which the externally specified data can be translated into the format defined in the StructureDescription. The translation is accomplished by reference to an external algorithm or script per the DataTypeTranslation that is part of each binding implementation (e.g., as illustrated in FIG. 25).

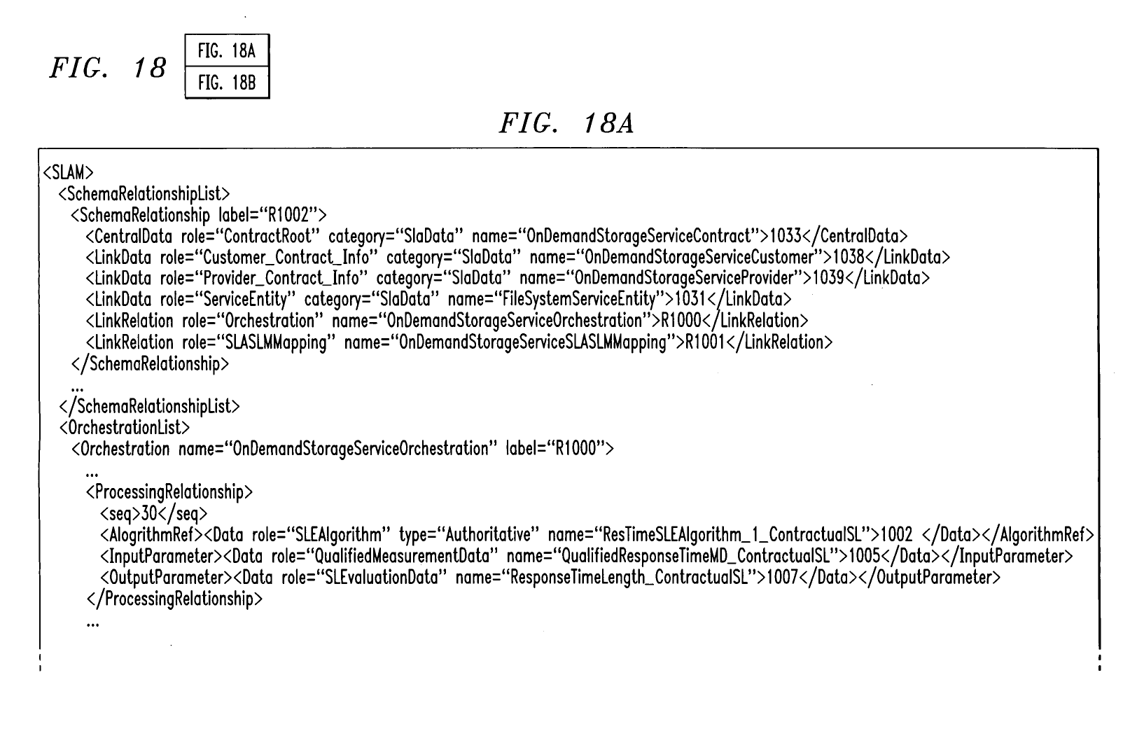

FIG. 16 illustrates in additional detail how within the management domain specification there is an opportunity to refine an SLMDataElement in successive steps. The leftmost template simply defines the structure to which all SLMDataElements of category InternalSlmData must conform. The middle template illustrates further refinement for a particular role/category/type. The rightmost template additionally includes a StructureDescription. Notice all these templates reside within the Management Domain Specification. In general, progressive refinement of this sort is population of other templates at the same level with additional details as shown below, typically at the SLM Management Domain Specification and Service Offering Specifications.

Furthermore, it is to be appreciated that FIG. 16 shows (at the template level) that a data element can be either “original” or “derived.” The difference is that “original” is data that is “external” to the SLM system, whereas “derived” is data that is maintained within the SLM system (derived from external sources). Advantageously, this feature of the invention allows the SLM to reuse intermediate results in SL computation without going out to the original stores. Notice that this is again represented within the “characteristics” of the SLMDataElement (<Source>).

FIG. 17 illustrates how a template may likewise be filled in accordance with the service offering specification and the contract instance specifications. The topmost template is again the most general. The Service Offering template (including infrastructure specific details) provides additional details defined by the particular offering and the bottommost “template” is populated with customer specific data and additional infrastructure data.

FIG. 18 illustrates a representation of the contract instance relationships that are to be managed in support of SLM processing, in particular the schema relationships, the flow graph processing relationships, and the SLA/SLM mapping relationships.

FIG. 19A illustrates a set of processing relationships that are applicable to SLA management. The figure illustrates that the actual measurement data as received form the external sources. In conjunction with inclusion data, exclusion data is passed to an adjudication algorithm for adjudication. The results of the adjudication algorithm are qualified measurement data. This is provided to a service level evaluation algorithm that is responsible for computation of the service level attainment. The results from this (SL evaluation result data) are then used in the computation of the business impact. The figure illustrates that these data and algorithms are precisely a processing sequence through the embodiment of the data and algorithms described earlier. The associations between the elements are defined in the Relationship Specification of the data model by a set of processing relationships. It should also be recognized that the data flow graph provided is an illustration on the capabilities of the system only. The data flow graph may be extended to include business impact assessment across several SLA's (inter-SLA business impact assessment) by extending the data flow graph “up” to a higher level.

The data model and data management framework are designed to be most flexible and accommodating to new requirements. In particular, as illustrated in FIG. 19A, the framework is designed to accommodate not just computation of contractual exposed business impact and SLA reporting, but can also be used for computations of non-contractual service level reporting scenarios, “what if” scenarios, etc. This is illustrated in FIG. 19A by the four topmost SLMElements (SLARefundReward, SL Business Impact, Non-contractual Action Penalty and Non-contractual BI for Event) which illustrate computations providing contractual SLA refund and reward data, and various non-contractual penalty values used for a variety of SLM purposes (e.g., the Non-contractual Action Penalty computes a business impact assessment to be used to compare action generating service level events in the context of SLM).

FIGS. 19B and 19C illustrate how the data flow graph of FIG. 19A is layered into Orchestrations and Processing Relationships. FIG. 19B illustrates that two relationships elements are used in support of the representation of these processing relationships, the first are called <ProcessingRelationship>'s as illustrated by box A of FIG. 19B (with an example provided in FIG. 21) which embody the association between a SLMAlgElement and a set of SLMDataElements; the second is called an <Orchestration> as illustrated by box B of FIG. 19B which describes the association of a set of processing relationships. An illustration of a representation of processing relationships is provided below (some ProcessingRelationships omitted for brevity).

In this example, the relationships are at the contract instance layer (that is, it refers to the algorithm and data relationships for a particular contract). The name field provides the nature of the Orchestration and the label is unique to the instance. The ProcessingRelationships provides a sequence field which is used to identify this Relationship within the Orchestration then the AlgorithmRef which references a particular SLMAlgElement and the Input/Output Parameter mapping (the role and name characteristics and the unique instance label). This provides the mechanism that effectively binds the elements to the parameters and is used for representation of intermediate results in the runtime data store.

The processing relationship can be interrogated in order to select some subset of the overall processing relationships, e.g., provide service level attainment results (only) by specifying the “start” and “end” points of a processing sequence. This is considered a part of the invention:

- <Orchestration name= “OnDemandStorageServiceOrchestration”
label=“R1000”>

- <ProcessingRelationship>

<seq>10</seq>
- <AlgorithmRef>

<Data role=“ExclusionQualificationAlgorithm”

type=“Authoritative”
name=“ScheduledMaintenanceTypeTranslationAlgorithm”>1017</Data>

</AlgorithmRef>
- <InputParameter>

<Data role=“ExclusionData”

name=“ScheduledMaintenance”>1003</Data>

</InputParameter>
- <OutputParameter>

<Data role=“ExclusionData”

name=“ActualMaintenance”>1004</Data>

</OutputParameter>

</ProcessingRelationship>
...

</Orchestration>

As described earlier, schema are also represented in all relationship specification layers through the use of SchemaRelationships as illustrated below. The purpose of these relationships is to show non-processing relationships between elements. The example below shows how a Contract Root element is related to the Customer and Provider information, the Service Entity, the Processing relationships and SLA/SLM Mapping:

<SchemaReiationshipList>

<SchemaRelationship label=“R1002”>

<CentralData role=“ContractRoot” category=“SlaData”

name=“OnDemandStorageServiceContract”>1033</CentralData>

<LinkData role=“Customer_Contract_Info” category=“SlaData”

name=“OnDemandStorageServiceCustomer”>1038</LinkData>

<LinkData role=“Provider_Contract_Info” category=“SlaData”

name=“OnDemandStorageServiceProvider”>1039</LinkData>

<LinkData role=“ServiceEntity” category=“SlaData”

name=“FileSystemServiceEntity”>1031</LinkData>

<LinkRelation role=“Orchestration”

name=“OnDemandStorageServiceOrchestration”>R1000</LinkRelation>

<LinkRelation role=“SLASLMMapping”

name=“OnDemandStorageServiceSLASLMMapping”>R1001</LinkRelation>

</SchemaRelationship>
<SchemaRelationship label=“R1003”>

<CentralData role=“ServiceEntity” category=“SlaData”

name=“FileSystemServiceEntity”>1031</CentralData>

<CentralData role=“ServiceEntity” category=“InternalSlmData”

name=“FileSystemServiceEntity”>1032</CentralData>

<LinkData role=“ServiceLevel” category=“SlaData”

name=“ResponseTimeSL_Contractual”>1037</LinkData>

<LinkData role=“ServiceLevel” category=“InternalSlmData”

name=“ResponseTimeSL_NonContractual”>1040</LinkData>

<LinkData role=”ServiceEntityRefundData” category=”InternalSlmData”

name=“FileSystemServiceRefund”>1036</LinkData>

<LinkData role=“SERefundBIAlgorithm” category=“InternalSlmData”

name=“FileSystemServiceRefundAlgorithm”>1030</LinkData>

<LinkData role=“SLMeasurementSource” category=”SlaData”

name=“RequestResponseTimeMeasureSource”>label of
SLMeasurementSource</LinkData>

...

</SchemaRelationship>

SLA/SLM for equivalent elements are also represented as illustrated below. The purpose of these relationships is to allow the SLA data (which may include text clauses and other non-machine processable artifacts) to be associated with their equivalent SLM element and association of several SLM algorithms with a SLA Contract algorithm. In the example of FIG. 18 (the relevant section also shown below), the relationship defines how the service level evaluation algorithm as described in the contract (represented by FIG. 24B) is associated with two internal algorithms (represented by FIGS. 24A and 24C):

</SLASLMMapping>

...
<InterCategoryRelationship role=“SLEAlgorithm”>

<Group category=“InternalSlmData”>

<Member name=“ResTimeSLEAlgorithm_1_ContractualSL” >1022</Member>
<Member name=“ResTimeSLEAlgorithm_2_ContractualSL” >1023</Member>

</Group>
<Group category=“SlaData”>

<Member name=“ResTimeSLEAlgorithm_ContractualSL” >1021</Member>

</Group>

</InterCategoryRelationship>
...

</SLASLMMapping>

Notice that FIG. 24B provides a list of static attributes that are contract defined and are copied over to the relevant internal SLMAlgElement fields when the contract instance is populated, along with a list of dynamic attributes that are described textually and are populated with SLMElementNames when the contract instance is populated.

In addition to the relationships that are manifest at the contract instance level, there are additional references that are implied and used in the design. For example, the design has made reference to multiple ontologies used in support of defining the characteristics of a particular SLMDataElement or SLMAlgElement. It is understood that there may be many such characteristics and that each of these characteristics may be refined into many levels. In a similar manner, there is the representation of SLMDataElement class hierarchies for the nature of the algorithms that must be represented. In one implementation, these are maintained by the use of the “name” attribute as one of the characteristics by the use of the underbars (_'s) on the naming convention. These names uniquely identify a type (or class) of algorithm and/or data at the contract instance level. These relationships are likewise represented at the relationship part of the SLA Management Domain Specification (i.e., top right part of the Data Model of FIG. 5) as shown below. It is understood that there are many alternate embodiments to accomplish the same goal:

<OntologyMapping>
<Characteristics>

```
<Category>
  <SlaData/>
  <InternalSlmData>
```

<CustomerExposedInternalSLMData/>
<ProviderInternalSLMData/>

</InternalSlmData>
</Category>
<Role>

<AcrualMeasurementData>
<QualifiedMeasurementData>
<InclusionExclusionData>
<SLEvaluationData>
<SLETableTarget>
...

</Role>
<Name>

<ResponseTimeSL>

<ResponseTimeSL_Contractual>
<ResponseTimeSL_NonContractual>

<ResponseTimeSL>
...

</Name>
...

</Characteristics>
<OntologyMapping>

The remainder of this section provides details on how the elements and data model as described are used in conjunction with the data management framework to support the effective computation of exposed Business impact in accordance with the flow graph that was provided in FIG. 12A. For illustrative purposes and without loss of generality, only a single step in the execution sequence is annotated. Typically, the Flow Knowledge Base for a particular contract will be accessed by obtaining the relationship data from the ContractRoot SLMDataElement. The ContractRoot may be located by the unique name of the contract, e.g., “OnDemandStorageService_CompanyABC.”

FIG. 19C illustrates an execution path through the data flow graph and how it is represented as an orchestration associated with the contract instance. A small piece of the overall orchestration is extracted (dotted oval) and will be further explained below.

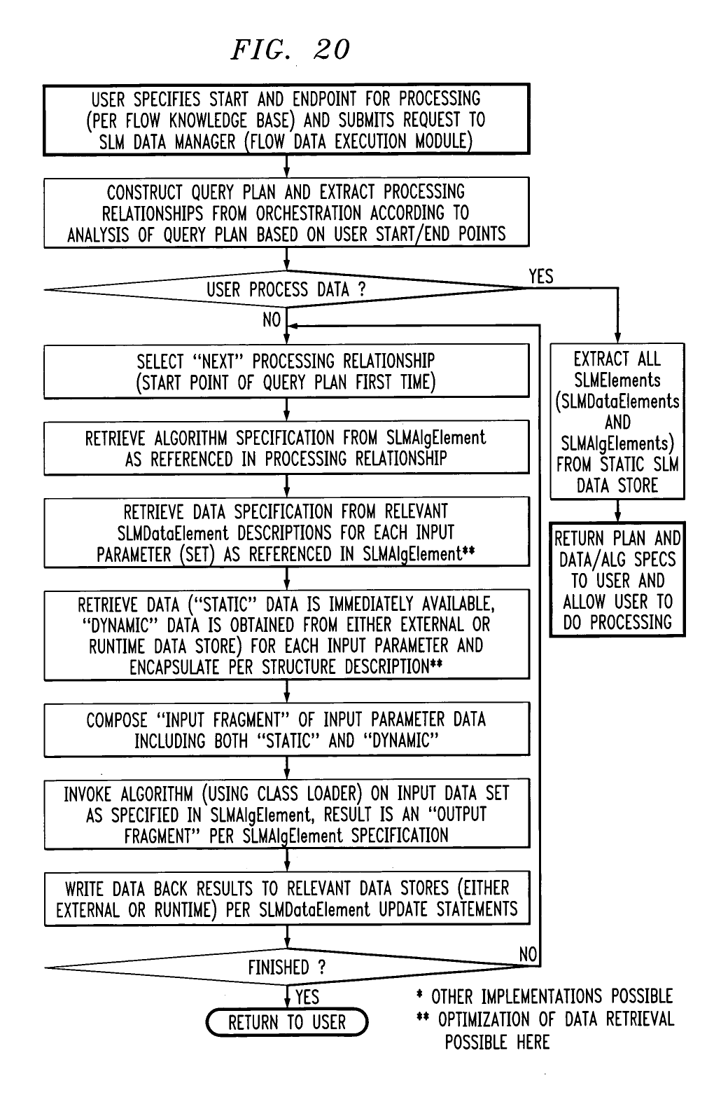

FIG. 20 illustrates one possible embodiment for the computation of the processing flow between two points with in the data flow graph. The two points represent the “start” of the processing flow and the “end” of the processing flow. The start and end points are provided by the “user” (i.e., external application) as part of a “flow data” processing request. It should be noted that there are other ways in which the computation may be accomplished using the same data in the data store. Notice also that the actual computation need not be performed by the data management framework, as illustrated in the lower left rounded box. Instead the external application, armed with the relevant data, may perform the computation steps (application of algorithms to data) outside the data management framework.

FIG. 21 illustrates the processing relationship for the particular step to be demonstrated (the first step in service level evaluation) which takes as input “Qualified Measurement Data” and generates “Response Time Lengths”. These are then combined in the next processing step to compute the Service Level attainment result. The relationship is accessed in accordance with the query plan since it lies between the two specified end points. The inputs to the algorithm as specified in SLMElement label=“1022” are to be obtained from the SLMElement label=“1005”. Likewise, the outputs will be put into a location specified by SLMElement label=“1007”. Notice that these endpoints will associate with SLMDataElements for this form of request. The data flow graph is traversed using the “role” and “name” attributes.

FIG. 22 illustrates the data specification (i.e., SLMDataElement) for the qualified measurement data that will form the input for the demonstration step. The actual data is retrieved from the runtime data store (since the values are intermediate) in accordance with the StructureBinding. The format of the data to be retrieved is defined in the StructureDescription, e.g., using an XML Schema file (not shown). Notice that the actual data stores (runtime data base and external databases) are not constrained by this design. The design is flexible in that the data stores may be either structured (as is the case in the above-described implementation) or can be semi-structured (e.g., native XML data stores). Notice that the translation between the external data format and format described in the StructureDescription is accomplished by application of the DataTypeTranslation which can be an arbitrary algorithm or script. In the example shown, the translation is performed using a Java class residing in a jar file. These kinds of decisions are recognized as implementation decisions.

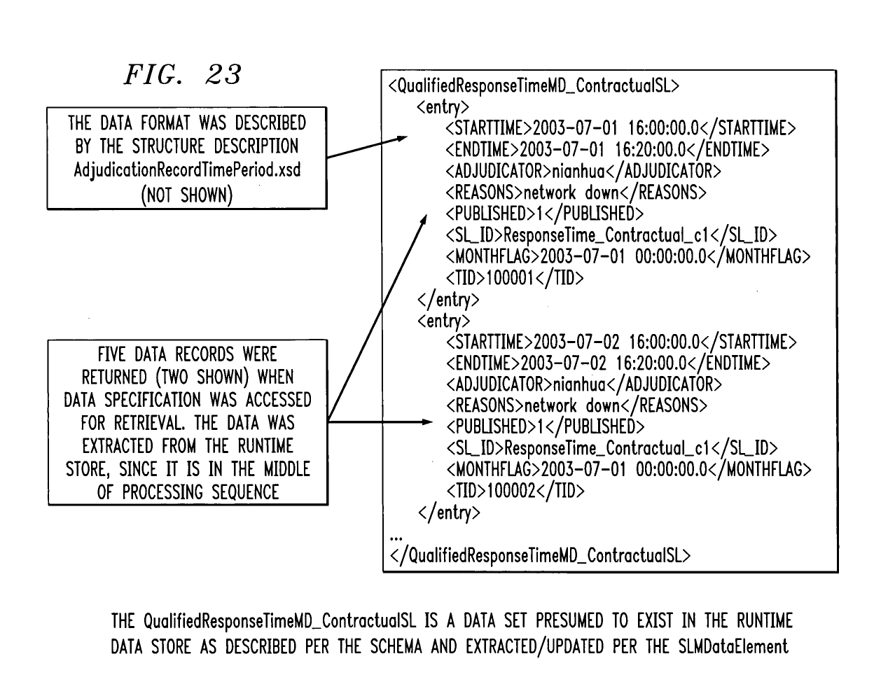

FIG. 23 illustrates an example of the data that would be retrieved from the data store (runtime data in this case) after translation.

FIG. 24 illustrates the algorithm specification that describes the nature of the data to be passed into and out of the algorithm. Parameters are extracted from the relevant SLMDataElements in accordance with the parameter list, that is the algorithm expects a data set which is comprised of four input elements: StartTime, EndTime, DurationUnit, InputMonthFlag, and two output elements: DurationValue, OutputMonthFlag. The source (or sink) locations for dynamic parameters are identified by the SLMElementName/AttrName combination which refer to Elements extracted from the relevant datasets. For example, the fourth input of FIG. 24A will be data with Element name MonthFlag extracted from the SLMDataSpecification of FIG. 22 as illustrated in FIG. 23. Static data may be passed in immediately. The location of the actual algorithm to be invoked is also provided in the algorithm specification via the ExecutionContext.

FIG. 25 illustrates the data specification (i.e., SLMDataElement) for the qualified measurement data that will form the output for the demonstration step. The actual data is stored into the runtime data store (since the values are intermediate) in accordance with the StructureBinding. The retrieved form of the data to be stored is defined in the StructureDescription, e.g., using an XML Schema file (not shown).

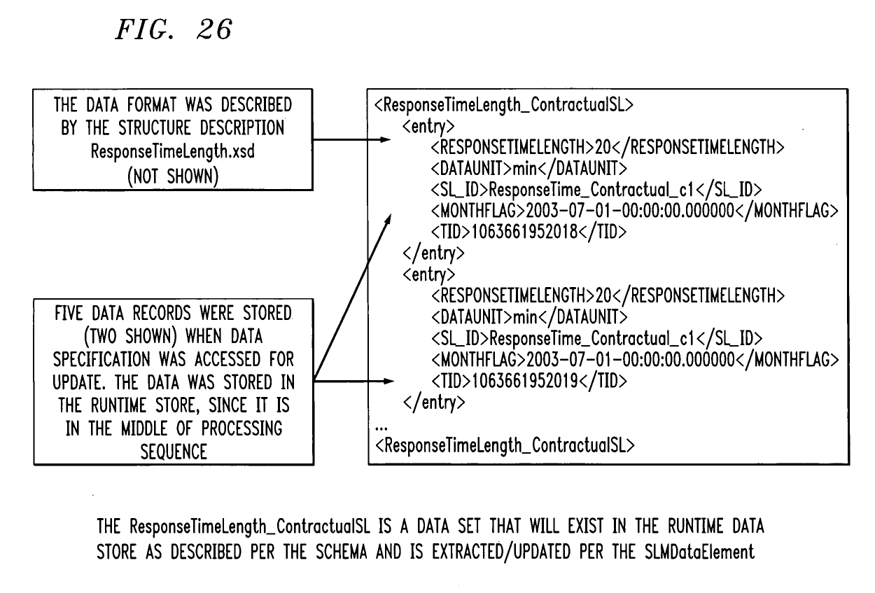

FIG. 26 illustrates an example of the data that would be stored into the data store (runtime data in this case) prior to translation.

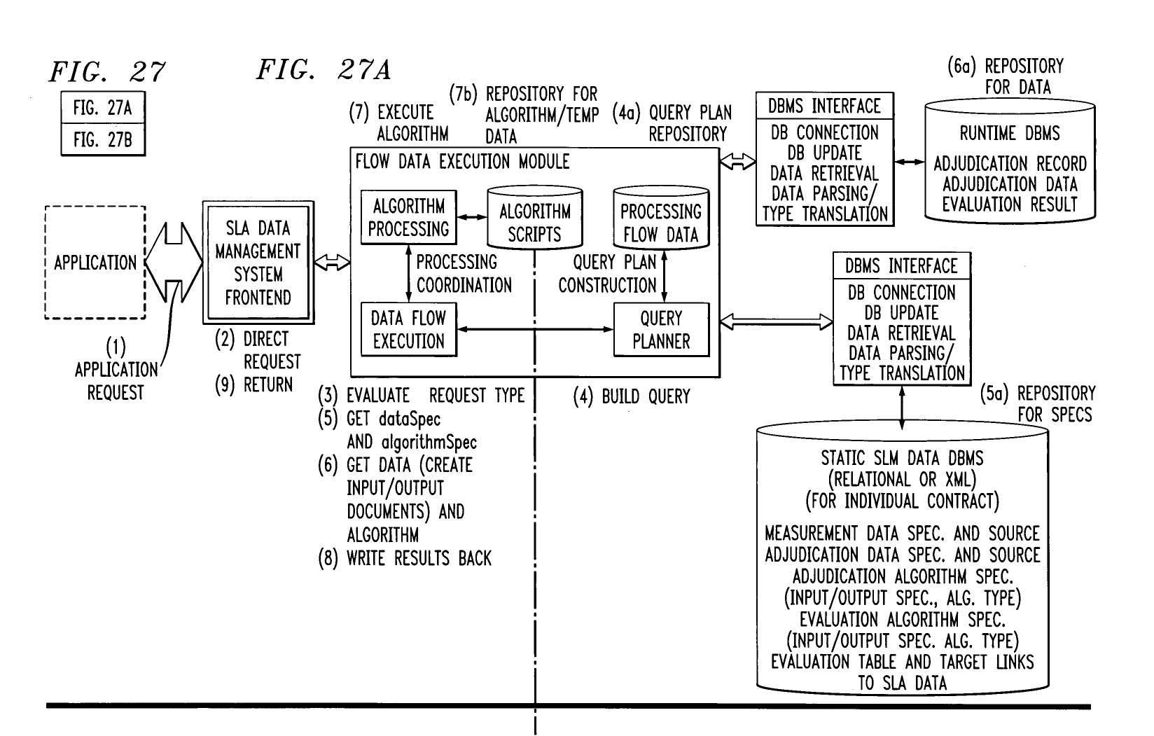

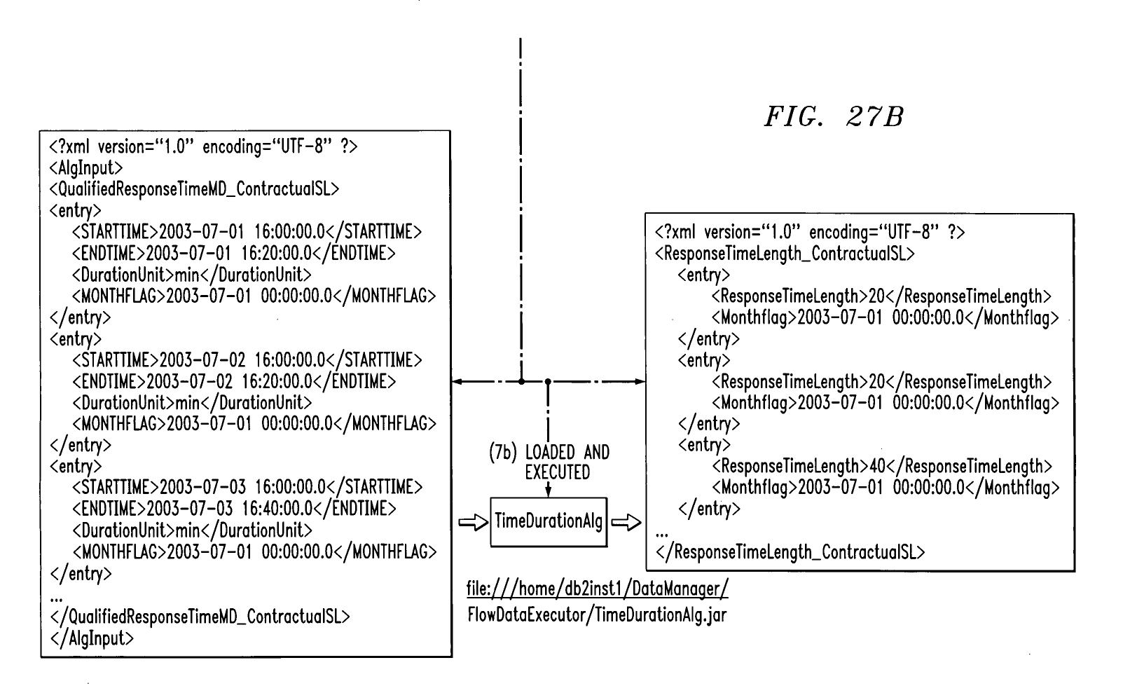

FIG. 27 illustrates how the processing step is handled by the extensible data management framework and how the data is retrieved, processed by the algorithm and returned back into the repository. In response to receipt of (step 1) a data flow processing request from the application (e.g., an SLA Action Manager), the FrontEnd directs (step 2) the data flow processing request to the data flow processing module. The module then evaluates (step 3) the nature of the request, builds (step 4) a query plan against the Static SLM data store using the data flow graph, gets (step 5) the data specification and algorithm specification, uses these to extract the data from the runtime data store (or external stores as needed) and select the appropriate algorithm (steps 6 and 6a), loads and executes (steps 7 and 7a) the algorithm and then writes the data back into the appropriate repositories in accordance with the data specifications (step 8).

5. Alternative Embodiment Using Relational Data Store

In accordance with an alternative embodiment of the invention, the data management interface permits an implementation that may be less flexible than the embodiments described above, but has the benefit of relying less on semi-structured data store requirements.

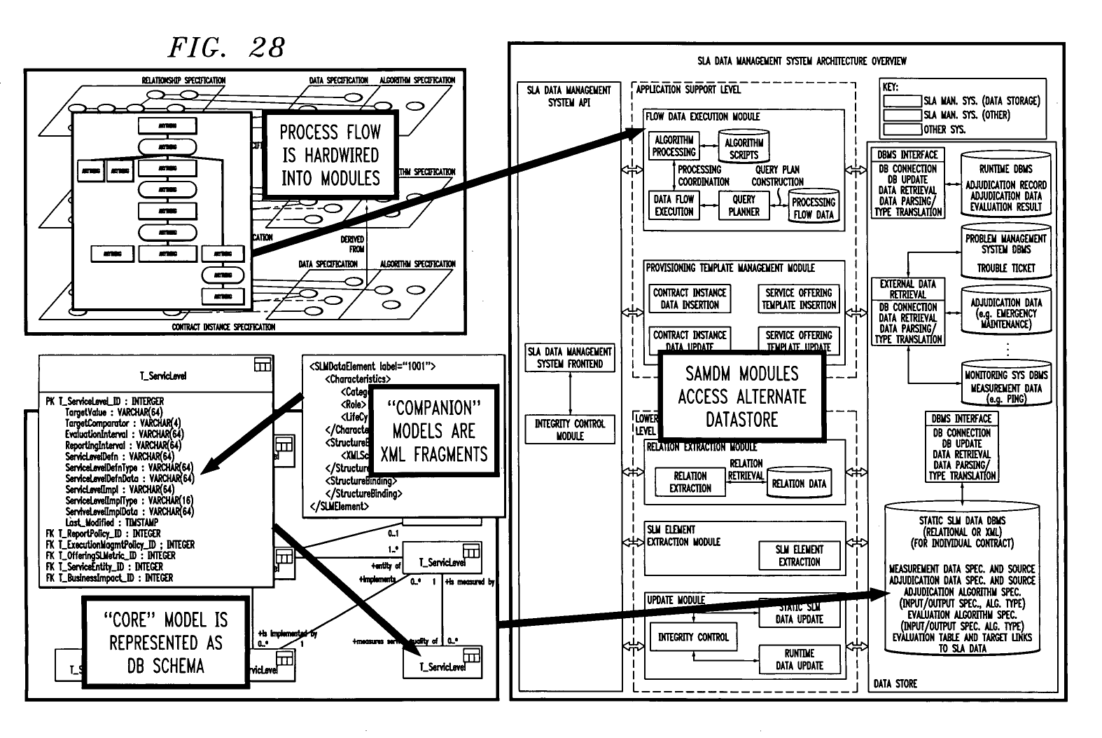

FIG. 28 illustrates how the Flow Data Execution module may be replaced by a “hardwired” processing flow (i.e., a data flow graph decided a-priori and coded into the module) and the Static SLM Data Store may be implemented using a relational schema. In this embodiment, the external view of the extensible data store offers similar services, albeit without the flexibility and extensibility of the previously-described embodiments.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. A method of managing data associated with a given domain, comprising the steps of:
maintaining a specification of data attributes representing one or more types of data to be managed;
maintaining a specification of algorithms representing one or more types of operations performable in accordance with the data attributes; and
maintaining a specification of relationships representing relationships between the data attributes and the algorithms;
wherein the data attribute specification, the algorithm specification and the relationship specification are maintained in a storage framework having multiple levels, the multiple levels being specified based on the given domain with which the data being managed is associated.

2. The method of claim 1, wherein the multiple levels of the storage framework comprise hierarchical levels such that one level of the storage framework is a refinement of another level of the storage framework.

3. The method of claim 1, wherein the hierarchical levels of the storage framework maintain at least one of the data attributes, the algorithms and the representations in a template-based representation.

4. The method of claim 1, wherein data attributes are represented so as to expose at least one of a nature of the data through a plurality of ontologies, a structure of the content of the data, and a structure of a mechanism by which the data may be retrieved.

5. The method of claim 1, wherein the algorithms are represented so as to expose at least one of a nature of the algorithms through a plurality of ontologies, a structure of parameters of the algorithms expressed according to a nature of the data attributes, and a structure of a mechanism by which code for the algorithms may be retrieved.

6. The method of claim 1, wherein the relationships between the data attributes and the algorithms are represented in support of a plurality of computations for computing domain-specific results.

7. The method of claim 1, further comprising the step of, in accordance with an application, retrieving at least a portion of the data attributes and the algorithms to perform a computation sequence.

8. The method of claim 7, wherein the computation sequence is based on a specification of a computation start point and a computation end point as described by a data flow graph.

9. The method of claim 1, further comprising the step of, in accordance with an application, one of creating and managing templates.

10. The method of claim 1, further comprising the step of, in accordance with an application, one of populating and managing a template instance for a particular template.

11. The method of claim 1, wherein relationships between data attributes which support non-processing relationships are maintained in support of a plurality of functions.

12. The method of claim 1, wherein the data attributes and the algorithm are verifiable with respect to at least one of consistency and correctness.

13. The method of claim 1, further comprising the step of deferring a decision as to whether to apply a computation step in support of a desired result from a computation sequence in accordance with metadata within the storage framework.

14. The method of claim 1, wherein a relationship is maintained between data at a domain specification level of the storage framework and an instance specification level of the storage framework.

15. The method of claim 1, further comprising the step of, in accordance with an application, traversing one or more processing relationships among a plurality of templates and template instances maintained in accordance with the storage framework so as to ascertain one or more computation relationships.

16. The method of claim 1, wherein the given domain comprises a service level management domain.

17. The method of claim 16, wherein the service level management domain supports proactive management of a plurality of service level agreements allowing one or more of service level agreement reporting, a customer-related business impact evaluation and a service provider internal business impact evaluation in accordance with relationships represented within flow graphs associated with the storage framework.

18. The method of claim 16, wherein the data attributes comprise service level management data elements, the algorithms comprise service level management algorithms, and the relationships comprise service level management relationships.

19. The method of claim 18, wherein the service level management data elements comprise one or more of service level agreement contract data, internal service level management data, and service level management algorithm specifications.

20. The method of claim 18, wherein the service level management algorithms comprise one or more of measurement data adjudication and service level evaluation for a particular category of data element.

21. The method of claim 18, wherein the service level management relationships comprise evaluation in accordance with flow graph specifications and relationship management between service level agreement data and internal service level management data.

22. The method of claim 19, wherein relationships between service level agreement contract data and other service level management data are maintained in support of a plurality of service level management functions.

23. The method of claim 16, further comprising the step of, in accordance with an application, traversing one or more service level management related processing relationships among a plurality of templates and template instances maintained in accordance with data flow graphs as maintained within the storage framework so as to ascertain one or more service level management computation relationships.

24. The method of claim 16, further comprising the step of prioritizing one or more data access requests based on a service provider business impact assessment to the storage framework so as to sequence data results in accordance with one or more service management objectives.

25. The method of claim 1, wherein data is obtainable from one or more semantically equivalent data sources.

26. The method of claim 1, wherein data is one of original data and derived data, wherein original data is data external to the storage framework and derived data is data maintained within the storage framework

27. Apparatus for managing data associated with a given domain, comprising:
a memory for storing a storage framework; and
at least one processor coupled to the memory and operative to: (i) maintain a specification of data attributes representing one or more types of data to be managed; (ii) maintain a specification of algorithms representing one or more types of operations performable in accordance with the data attributes; and (iii) maintain a specification of relationships representing relationships between the data attributes and the algorithms; wherein the data attribute specification, the algorithm specification and the relationship specification are maintained in the storage framework which has multiple levels, the multiple levels being specified based on the given domain with which the data being managed is associated.

28. An article of manufacture for managing data associated with a given domain, comprising a machine readable medium containing one or more programs which when executed implement the steps of:
maintaining a specification of data attributes representing one or more types of data to be managed;
maintaining a specification of algorithms representing one or more types of operations performable in accordance with the data attributes; and
maintaining a specification of relationships representing relationships between the data attributes and the algorithms;
wherein the data attribute specification, the algorithm specification and the relationship specification are maintained in a storage framework having multiple levels, the multiple levels being specified based on the given domain with which the data being managed is associated.

29. A data store for use in managing data associated with a given domain, comprising:
a first data storage portion for maintaining a specification of data attributes representing one or more types of data to be managed;
a second data storage portion for maintaining a specification of algorithms representing one or more types of operations performable in accordance with the data attributes; and
a third data storage portion for maintaining a specification of relationships representing relationships between the data attributes and the algorithms;
wherein the data attribute specification, the algorithm specification and the relationship specification are maintained in accordance with multiple leves, the multiple levels being specified based on the given domain with which the data being managed is associated.

30. A method of providing a service for managing data associated with a given domain, comprising the step of:
a service provider providing a data management system in accordance with one or more customers, the data management system being operative to: (i) maintain a specification of data attributes representing one or more types of data to be managed; (ii) maintain a specification of algorithms representing one or more types of operations performable in accordance with the data attributes; and (iii) maintain a specification of relationships representing relationships between the data attributes and the algorithms; wherein the data attribute specification, the algorithm specification and the relationship specification are maintained in a storage framework having multiple levels, the multiple levels being specified based on the given domain with which the data being managed is associated.

31. The method of claim 30, wherein service level agreement report data is generated for a customer in accordance with one or more clauses of a service level agreement such that the one or more clauses are mapped to service level agreement data and is associated with a service provider representation of the data using one or more relationship mappings and service level agreement report data is generated in accordance with a sequence of processing relationships.

32. The method of claim 30, wherein customer business impact assessment data is generated for a customer in accordance with one or more expressed wishes of a customer such that one or more business impact evaluation data wishes of the customer are mapped to customer-related business impact data and is associated with a service provider representation of service level management data using relationship mappings and the customer-related data is generated in accordance with a sequence of processing relationships.

33. The method of claim 32, wherein the business impact evaluation data may provide a customer with one or more customer relevant business impact assessments.

34. The method of claim 33, wherein the one or more customer relevant business impact assessments comprise one or more customer relevant what-if scenario result data sets.

35. The method of claim 30, wherein service provider business impact management data is generated for a customer in accordance with one or more wishes of the service provider such that the one or more service provider business impact evaluation data wishes are mapped to provider-facing business impact data and is associated with a service provider representation of service level management data using relationship mappings and service level management business impact data of the service provider is generated in accordance with a sequence of processing relationships.

36. The method of claim 35, wherein business impact evaluation data provides a service provider with one or more provider relevant business impact assessments.

37. The method of claim 35, wherein the one or more provider relevant business impact assessments comprise one or more what-if scenario result data sets and aggregations of business impact across multiple customers.
